(19) United States
(12) Patent Application Publication
(10) Pub. No.: US 2026/0063433 A1
(43) Pub. Date: Mar. 5, 2026

(54) DYNAMIC ROUTE SAFETY SCORING

(71) Applicant: State Farm Mutual Automobile Insurance Company, Bloomington, IL (US)

(72) Inventors: David Alan Dohrmann, Mesa, AZ (US); Olivia Anne Nauman, Phoenix, AZ (US); Karthikeyan Srinivasan, Peoria, AZ (US); Daniel Baker Wilson, Phoenix, AZ (US); David Nicholas Brewer, Queen Creek, AZ (US); Hanpei Zhang, Mesa, AZ (US); Michael Allan Niehaus, Glendale, AZ (US)

(73) Assignee: State Farm Mutual Automobile Insurance Company, Bloomington, IL (US)

(21) Appl. No.: 18/958,921

(22) Filed: Nov. 25, 2024

Related U.S. Application Data
(60) Provisional application No. 63/687,890, filed on Aug. 28, 2024.

(51) Int. Cl. G01C 21/34; G01C 21/36

(52) U.S. Cl. CPC G01C 21/3461; G01C 21/3492; G01C 21/3617

(57) ABSTRACT

A transportation system for generating transportation recommendations may (1) receive a transportation request associated with a user; (2) identify, using the transportation request, a first location and a second location associated with the transportation request; (3) determine, using the first location and the second location, routes between the first location and the second location; (4) receive travel data associated with each of the plurality of the routes, the travel data including information indicating a current or predicted future travel condition along each of the routes; (5) generate, using historic transportation characteristics associated with the user and the travel data, a safety or other score for each route, the score indicating an estimated level of safety of traveling along the route; and/or (6) generate a user interface providing indicators associated with the scores of the routes.

### CROSS-REFERENCE TO RELATED APPLICATIONS

This application claims priority to and the benefit of U.S. Provisional Patent Application Ser. No. 63/687,890, filed Aug. 28, 2024, which is incorporated herein by reference in its entirety.

### FIELD OF THE INVENTION

The present disclosure generally relates to transportation systems. More particularly, the present systems and methods relate to using a transportation system to provide transportation recommendations that allow individuals to assess potential risks associated with different travel routes.

### BACKGROUND

Individuals may travel between various locations using different transportation routes. Each route may also involve an individual encountering different travel conditions (e.g., a physical condition of a road, a traffic density or common traveler tendencies, travel tendencies of other travelers, etc.) along each of the available routes. For example, an individual may encounter a higher traffic density and/or travelers traveling at higher speeds along a first route (e.g., a highway or freeway, for example during rush hour, etc.), or alternatively an individual may encounter a lower traffic density and/or travelers traveling at slower speeds along a second route (e.g., a side road or back road, for example during rush hour, etc.). Similarly, an individual may encounter travelers that tend to drive at slower speeds on a route that includes slower speed limits (e.g., a side or back road), or alternatively an individual may encounter travelers that tend to drive at higher speeds on a route that includes higher speed limits (e.g., a three-lane road, a highway, etc.).

However, different transportation routes and/or different travel conditions (e.g., a physical condition of a road, construction, travelers an individual may encounter, etc.) along each of those routes may present different risks to an individual when traveling between locations. In some instances, an individual's own travel tendencies (e.g., historic travel tendencies, current travel tendency, etc.), combined with the travel conditions along different transportation routes, may present different risks to an individual when traveling between locations. Assessing the potential risks associated with different transportation routes and/or travel conditions may be difficult. As such, conventional techniques may have certain ineffectiveness, inefficiencies, encumbrances, and/or other drawbacks when evaluating and/or assessing the potential transportation routes available to individuals.

### BRIEF SUMMARY

A computer system may be provided that generates recommendations related to different transportation options, such as to facilitate (i) reducing and/or preventing potential damage (e.g., damage to a vehicle or other property, etc.) while traveling, (ii) reducing and/or preventing potential injury (e.g., personal injury, financial injury, etc.) while traveling, and/or (iii) reducing and/or preventing potential health and/or safety risks while traveling. For instance, different travel routes may be analyzed to assess and/or calculate the potential risks (e.g., risk scores) associated with traveling along each of the respective routes. In some embodiments, the travel characteristics (e.g., driving habits or tendencies, etc.) of an individual (e.g., historic driving habits or tendencies, current driving characteristics, etc.), as well as the travel conditions (e.g., road conditions, road elements along a route, common or frequent traffic density, common or frequent traveler tendencies, other travelers an individual may encounter while traveling, etc.) along the routes may be used to determine the potential risks associated with the individual traveling along each route.

In certain embodiments, travel characteristics of the user themselves (e.g., historic driving habits or tendencies of the user, current driving conditions of the user, etc.) and/or the route itself (e.g., road elements along the route, historic accident information, construction events, common traffic density, common traveler tendencies etc.), and/or other suitable information may be used in determining the potential risks associated with traveling along each route. A user interface may be presented to a user, such as on a mobile device or other computing device, displaying the risk scores (e.g., one or more indicators) associated with one or more of the routes (e.g., indicating a route that offers a lowest estimated risk while traveling, etc.). By providing the risk scores associated with each available route, the systems and methods described herein may advantageously provide users with the ability to assess the risks associated with different travel options and/or allow users to make travel decisions that reduce potential damage, injury, and/or health and/or safety concerns while traveling.

In one aspect, a computer system for generating a transportation recommendation and/or displaying transportation options may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. For example, in one instance, the computer system may include one or more processors and one or more non-transitory memories storing processor-executable instructions that, when executed by the one or more processors, cause the system to perform several operations, including (1) receiving a transportation request associated with a first user; (2) identifying, using the transportation request, a first geographic location and a second geographic location associated with the transportation request; (3) determining, using the first geographic location and the second geographic location, a plurality of routes between the first geographic location and the second geographic location; (4) receiving travel data associated with each of the plurality of routes, the travel data indicating at least one of a current or predicted future travel condition along each of the plurality of routes; (5) generating, using historic transportation characteristics associated with the and the travel data, a risk score for each of the plurality of routes, the risk score indicating an estimated risk of traveling along the route; and (6) generating a user interface providing one or more indicators associated with the risk scores of one or more of the plurality of routes.

For instance, in certain embodiments, the historic transportation characteristics of the user includes at least one of an average transportation speed, an average number of stops during a travel event, or an average travel time.

In some embodiments, wherein the current or predicted future travel conditions indicate at least one of a road density score indicating a number of crossroads along a route, a construction rating indicating one or more construction events along a route, or an obstruction rating indicating one or more obstruction events along a route. Additionally or alternatively, in certain embodiments the current or predicted future travel conditions indicate at least one of a traveler speed along a route, a frequency of traveler lane changes along a route, a frequency of traveler acceleration along a route, and a frequency of traveler deceleration along a route.

In certain embodiments, the functionality and/or operations may include receiving travel data associated with the user, the travel data indicating a real-time travel characteristic associated with the user, the real-time travel characteristic including a current transportation speed of the user compared to an average transportation speed associated with the user, where generating the risk scores for each of the plurality of routes includes generating the risk scores for each of the plurality of routes using the travel data associated with the user. The functionality and/or operations may also include providing a recommended route of the plurality of routes, wherein the recommended route has a risk score indicating a lowest estimated risk of the estimated risks of traveling along each of the plurality of routes.

In some embodiments, the functionality and/or operations may include (i) receiving user travel data including geolocation information of the user as the first travels between the first geographic location and the second geographic location, and (ii) comparing the user travel data with historical travel data associated with the plurality of routes to verify a recommended route. In certain implementations, the functionality and/or operations may include providing, using the verification of the recommended route, the user interface including at least one insurance policy parameter associated with opting to travel along the recommended route.

In some implementations, the functionality and/or operations may include (1) receiving a user preference indicating a relative preference between travel characteristics associated with traveling between the first geographic location and the second geographic location; and/or (2) selecting a recommended route from the plurality of routes using the user preference.

In some embodiments, generating the user interface includes generating the user interface providing the risk scores for each of the plurality of routes. In some implementations, the functionality and/or operations may include (1) receiving a selection of a route from the plurality of routes; and/or (2) providing, using the selected route, a recommended route via the user interface.

In another aspect, a computer system for generating a transportation recommendation and/or displaying transportation options may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. For example, in one instance, the computer system may include one or more processors and one or more non-transitory memories storing processor-executable instructions that, when executed by the one or more processors, cause the system to perform several operations, including (1) receiving a transportation request associated with a first user; (2) identifying, using the transportation request, a first geographic location and a second geographic location associated with the transportation request; (3) determining, using the first geographic location and the second geographic location, a plurality of routes between the first geographic location and the second geographic location; (4) receiving travel data associated with a second user, the travel data including geolocation information of the second user indicating a predicted future location of the second user is along at least one of the plurality of routes; (5) generating, using historic transportation characteristics associated with the second user, a risk score for each of the plurality of routes, the risk score indicating an estimated risk of traveling along the route; and/or (6) generating a user interface providing one or more indicators associated with the risk scores of one or more of the plurality of routes. The computer system may include additional, less, or alternate functionality, including that discussed elsewhere herein.

For instance, in certain embodiments, the travel data including the geolocation information of the second user is received in real-time. In some implementations, the historic transportation characteristics of the second user includes at least one of an average transportation speed, an average number of stops during a travel event, or an average travel time. In various implementations, the first user and the second user are enrolled in a transportation program associated with an entity.

In certain embodiments, the functionality and/or operations may include providing a recommended route of the plurality of routes, wherein the recommended route has a risk score indicating a lowest estimated risk of the estimated risks of traveling along each of the plurality of routes. Additionally or alternatively, the functionality and/or operations may include (1) receiving geographic data associated with the plurality of routes, the geographic data including at least one of (i) a road density score indicating a number of crossroads along a route; (ii) a construction rating indicating one or more construction events along a route; and/or (iii) an obstruction rating indicating one or more obstruction events along a route; and/or (2) generating the risk scores for each of the plurality of routes using the geographic data.

In some implementations, the functionality and/or operations may include (1) receiving first user travel data including geolocation information of the first user as the first user travels between the first geographic location and the second geographic location; and/or (2) comparing the first user travel data with historical travel data associated with the plurality of routes to verify a recommended route. Additionally or alternatively, the functionality and/or operations may include (3) providing, using the verification of the recommended route, the user interface including at least one insurance policy parameter associated with opting to travel along the recommended route.

In certain implementations, the functionality and/or operations may include (1) receiving a user preference indicating a relative preference between travel characteristics associated with traveling between the first geographic location and the second geographic location; and/or (2) selecting a recommended route from the plurality of routes using the user preference.

In some embodiments, generating the user interface includes generating the user interface providing the risk scores for each of the plurality of routes. In some implementations, the functionality and/or operations may include (1) receiving a selection of a route from the plurality of routes; and/or (2) providing, using the selected route, a recommended route via the user interface.

In another aspect, a computer-implemented method for generating a transportation recommendation and/or displaying environmental impacts or transportation modes and/or routes may be provided. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another. In one instance, the computer-implemented method may include, such as via one or more local or remote processors, transceivers, sensors, other electronic components, including those discussed elsewhere herein, and/or computer-readable storage media having instructions stored thereon executable by the processors, transceivers, sensors, and/or other electronic components, (1) receiving a transportation request; (2) identifying, using the transportation request, a first geographic location and a second geographic location associated with the transportation request; (3) determining, using the first geographic location and the second geographic location, a plurality of routes between the first geographic location and the second geographic location; (4) determining geographic data associated with each of the plurality of routes; (5) receiving travel data associated with a second user, the travel data including geolocation information of the second user indicating a predicted future location of the second user is along at least one of the plurality of routes; (6) generating, using historic transportation characteristics associated with the second user and the geographic data, a risk score for each of the plurality of routes, the risk score indicating an estimated risk of traveling along the route; and/or (7) generating a user interface providing one or more indicators associated with the risk scores of one or more of the plurality of routes. The method may include additional, less, or alternate functionality, including that discussed elsewhere herein.

For instance, in some embodiments, the travel data including the geolocation information of the second user is received in real-time. In some implementations, the historic transportation characteristics of the second user includes at least one of an average transportation speed, an average number of stops during a travel event, or an average travel time. In certain embodiments, the first user and the second user are enrolled in a transportation program associated with an entity.

In certain embodiments, the computer-implemented method may include, such as via one or more processors and/or other electronic components, providing a recommended route of the plurality of routes, where the recommended route has a risk score indicating a lowest estimated risk of the estimated risks of traveling along each of the plurality of routes.

In another aspect, a non-transitory computer readable medium having instructions stored thereon that, when executed by one or more processors, cause the one or more processors to perform various functionality and operations. For instance, the functionality and operations may include or direct (1) receiving a transportation request; (2) identifying, using the transportation request, a first geographic location and a second geographic location associated with the transportation request; (3) determining, using the first geographic location and the second geographic location, a plurality of routes between the first geographic location and the second geographic location; (4) receiving transportation data associated with a first user, the transportation data including historic transportation characteristics of the first user; (5) receiving travel data associated with a second user, the travel data including geolocation information of the second user indicating an a predicted future location of the second user is along at least one of the plurality of routes; (6) generating, using the historic transportation characteristics of the first user and historic transportation characteristics of the second user, a risk score for each of the plurality of routes, the risk score indicating an estimated risk of traveling along the route; and/or (7) generating a user interface providing indicators associated with each of the risk scores of each of the plurality of routes. The instructions may direct additional, less, or alternate functionality, including that discussed elsewhere herein.

For instance, in some implementations, the functionality and operations may include (1) receiving geographic data associated with each of the plurality of routes; and/or (2) generating the risk scores for each of the plurality of routes using the geographic data. Additionally or alternatively, the geographic data may include at least one of a road density score indicating a number of crossroads along a route, a construction rating indicating one or more construction events along a route, or an obstruction rating indicating one or more obstruction events along a route.

In some implementations, the functionality and operations may include providing a recommended route of the plurality of routes, where the recommended route has a risk score indicating a lowest estimated risk of the estimated risks of traveling along each of the plurality of routes.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

There are shown in the drawings arrangements which are presently discussed, it being understood, however, that the present embodiments are not limited to the precise arrangements and are instrumentalities shown, wherein:

FIG. 1 is a block diagram of an exemplary travel services computer system, according to some embodiments.

FIG. 2 is a block diagram of an exemplary computer-implemented transportation system, according to some embodiments.

FIG. 3 is a flow diagram of an exemplary computer-implemented or computer-based process of generating a transportation recommendation based upon risk scores of routes, according to some embodiments.

FIG. 4 is a flow diagram of an exemplary computer-implemented or computer-based process of generating a transportation recommendation based upon risk scores of routes, according to some embodiments.

FIG. 5 is a depiction of an exemplary user interface including a plurality of transportation options and associated risk scores, according to some embodiments.

FIG. 6 is a depiction of an exemplary user interface including a plurality of transportation options and a transportation recommendation, according to some embodiments.

FIG. 7 is a depiction of an exemplary user interface including a transportation recommendation and associated travel factors, according to some embodiments.

FIG. 8 is a depiction of an exemplary user interface including a transportation recommendation and associated travel factors, according to some embodiments.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments relate to, inter alia, a computer system that generates recommendations related to different types of transportation options (e.g., routes, etc.), such as to facilitate alleviating the potential risks associated with traveling to a desired location (e.g., potential damage, potential injury, potential health and/or safety risks, etc.). For instance, the characteristics of an individual traveler (e.g., historic travel tendencies, current travel tendency, etc.) and the travel conditions (e.g., road conditions, road elements along a route, common or frequent traffic density, common or frequent traveler tendencies, other travelers an individual may encounter while traveling, etc.) an individual may encounter while traveling along the different routes may be analyzed to assess and/or calculate the different risks associated with traveling along each route. For example, the travel characteristics of the individual themselves (e.g., driving habits, travel tendencies, etc.) and/or the travel conditions of each route itself (e.g., road conditions, road elements along the route, accident events, construction events, etc.), and/or other similar information may be used to determine potential risks associated with traveling along each route. Additionally or alternatively, the driving habits or travel tendencies of other travelers (e.g., a tendency to speed, a tendency to drive while distracted by a phone or radio, etc.) an individual may encounter while traveling may be used to determine potential risks associated with the individual traveling along each route.

In some instances, the potential risks (e.g., risk scores, etc.) associated with each available route are generated and/or determined using one or more trained models and/or different types of data (e.g., travel data, transportation data, user data, etc.) which, for example, may be difficult to obtain, otherwise inaccessible to a user, and/or no otherwise traditionally correlated and/or associated in assessing the potential risk associated with traveling to a destination. A user interface may be presented to a user, such as on a user mobile device, AR glasses, VR headset, or other computing device, displaying the risk scores associated with each route and/or a recommended route (e.g., a recommended route that offers a lowest estimated risk while traveling, etc.). By providing the risk scores associated with each available route and/or a recommended route, the systems and methods described herein may advantageously provide users with the ability to assess the risks associated with different travel options, for example to allow users to make travel decisions that reduce potential damage to personal property (e.g., a vehicle, another vehicle, etc.), potential injury (e.g., personal injury, financial injury, etc.), and/or health and/or safety concerns (e.g., health or safety risk associated with an accident, etc.) while traveling.

### OVERVIEW

Referring to the Figures, computer systems and computer-implemented methods for generating and/or providing a transportation recommendation may be provided. As described herein, the computer systems and computer-implemented methods may receive a transportation request and may identify a first location and a second location using the transportation request. Using the first and second locations, a plurality of routes between the first location and the second location may be determined. The computer system and computer-implemented methods may also include receiving travel data associated with an individual, including, for example, historic travel data (e.g., historic driving habits, historic travel tendencies, etc.) and/or current travel data (e.g., current driving characteristics, current driving tendencies, etc.). The computer system and computer-implemented methods may further be configured to receive travel data associated with each of the plurality of routes (e.g., road conditions, road elements along each of the routes, common or frequent traffic density information, common or frequent traveler tendencies, etc.). In some embodiments, the computer system and computer-implemented methods may include receiving travel data associated with a second user indicating a predicted future location of the second user is along at least one of the plurality of routes.

The computer system and computer-implemented methods may include generating a risk score for each of the plurality of routes using the travel data associated with the individual (e.g., historic travel habits, current travel characteristics, etc.) and the travel conditions (e.g., road conditions, traffic density information, etc.), where the risk score indicate an estimated risk of traveling along the route. In certain implementations, the risk scores for each of the plurality of routes is generated using, for example, historic transportation characteristics of a second user (e.g., a user an individual is predicted to encounter along one of the routes, etc.). The computer system and computer-implemented methods may also include selecting a recommended route from the plurality of routes using the risk scores for the plurality of routes and generating a user interface providing the recommended route.

Advantageously, one aspect of the computer systems and computer-implemented methods described herein may allow individuals to utilize (e.g., analyze, asses, review, evaluate, etc.) a risk score, safety score, and/or safety index (e.g., associated with traveling along a route) and/or a transportation recommendation, for example, to identify safety-conscious routes, which may be used to reduce and/or prevent potential damage (e.g., a potential accident, etc.), potential injury (e.g., personal injury, financial injury, etc.), and/or potential health and/or safety risks associated with traveling between certain locations (e.g., along certain routes) and/or the travel characteristics of the individual and the travel conditions (e.g., road conditions, road elements, traffic densities, traveler speeds, traveler tendencies, tendencies of other travelers, etc.) an individual may encounter while traveling.

Advancements in transportation infrastructure have afforded individuals the ability to choose between various routes when traveling between different locations. For example, an individual may decide to take a more efficient route to travel to work (e.g., a freeway that avoids traffic associated with construction), rather than a less efficient route (e.g., a side road that is a detour associated with the construction). Along each of the routes, an individual may also encounter different sets of travel conditions and/or driving conditions. For example, an individual may encounter an interchange that requires the individual to merge across three lanes of traffic in order to exit if the individual decides to take the more efficient route to work (e.g., the freeway to avoid construction, etc.), whereas the individual may encounter a roundabout if the individual decides to take a less efficient route (e.g., a side road or back road, etc.). Similarly, the individual may encounter travelers that travel at higher travel speeds and/or change lanes more frequently if the individual decides to take the more efficient rout to work (e.g., the freeway during rush hour, etc.), whereas the individual may encounter travelers that travel at slower speeds and/or change lanes less frequently if the individual decides to take a less efficient route (e.g., a side road or back road, etc.). In certain instances, an individual may encounter a group of inexperienced drivers if the individual decides to take the more efficient route to work (e.g., the freeway to avoid construction), whereas the individual may encounter a group of more experienced drivers, such as routine commuters, if the individual decides to take the less efficient route (e.g., the side road that is used as the detour).

While an individual may currently be able to evaluate travel times associated with various travel routes, it should be noted that different travel routes and/or the travel conditions (e.g., road conditions, road elements, traffic density characteristics, common travel characteristics, tendencies of travelers an individual may encounter, etc.) along the routes have different risks and/or potential safety implications, the impacts of which are less visible to individuals. Further, the travel tendencies of the individual themselves (e.g., historic travel tendencies, current travel characteristics, etc.), alone or in combination with the travel conditions along the routes, may present different risks and/or potential safety implications, the impacts of which may be less visible to the individuals. In addition to being interested in traveling efficiently between locations, individuals are now becoming more interested in travel options (e.g., routes, etc.) that offer safer travel options. As such, it would be advantageous to have a computer system that allows an individual to evaluate the safety impact of traveling between locations along different routes, for example by considering the impacts of the travel tendencies or characteristics of the individual and/or the travel conditions the individual may encounter.

Advantageously, one aspect of the computer systems and computer-implemented methods described herein may allow individuals to identify safety-conscious routes. For example, by assessing travel characteristics of the individual (e.g., historic and/or current travel characteristics, including, for example, a tendency to travel at a proper speed and/or otherwise obey the posted speed limit, a tendency to accelerate/decelerate as required, a tendency to travel at a reasonable following distance from other vehicles, a tendency to follow proper rules of the road and street signs, a tendency to obey stop signs, etc.) and/or travel conditions associated with one or more routes (e.g., road construction, a lane closure, traffic, weather conditions, traffic congestion due to time-of-day (rush hour) or year (holiday traffic), type of road, type of road elements a user may encounter, for example a roundabout, urban versus rural roads/travel, other travelers an individual may encounter along a route, etc.), the computer systems and computer-implemented methods described herein may identify a route that limits and/or reduces potential risks and/or safety implications to a user while traveling to a destination (e.g., risk of being in an accident, risk of getting injured, risk of getting stranded in inclement weather conditions, etc.). As a result, individuals may be incentivized to use routes that reduce potential damage (e.g., potential damage to a vehicle associated with an accident, etc.) and/or potential risks to a user or operator (e.g., potential personal injury, potential financial injury, potential financial risk, etc.).

Further, the computer systems and computer-implemented methods described herein advantageously allow individuals to assess safety-conscious routes in real-time, or near real-time. For example, the computer systems and computer-implemented methods described herein may be configured to provide risk scores associated with traveling (e.g., along a route, etc.) based upon information collected in real-time (e.g., real-time travel characteristics of the individual, real-time traveling conditions, for example real-time traffic or accident updates, real-time information associated with anticipated travelers a user may encounter, etc.) or near real-time. Further, the risk scores may be dynamically updated based upon current actual, real-time, and/or near real-time information. In this regard, the computer systems and computer-implemented methods described herein advantageously allow individuals to assess safety conditions associated with traveling using information that is provided (e.g., dynamically updated, etc.) based upon current travel characteristics of the user (e.g., the user is currently driving more cautiously than normal, for example due to inclement weather conditions, etc.) and/or traveling conditions (e.g., slower-than-normal travel conditions, higher than normal traffic density, etc. due to a snow storm, etc.), real-time travel updates, anticipated traveling conditions, and/or a combination thereof, which may allow users to assess safety conditions while traveling more accurately.

Yet further, and as described herein, the computer systems and computer-implemented methods described herein advantageously allow individuals to assess safety-conscious routes using information that is otherwise not normally accessible and/or considered in assessing safety conditions. For example, the computer systems and computer-implemented methods described herein may be configured to provide risk scores associated with characteristics of individual travelers themselves, which may not otherwise be known and/or considered by the individual (e.g., a tendency to drive more cautiously when merging across multiple lanes, a tendency to drive more cautiously when encountering a roundabout, a tendency to obey posted speed limits when traveling on highways or freeway, etc.). Further, the computer systems and computer-implemented methods described herein may be configured to provide risk scores associated with travel conditions that a user may not otherwise know that they could encounter along a route (e.g., merging across several lanes, a roundabout, travelers commonly traveling above posted speed limits, travelers frequently changing lanes, travel tendencies of other travelers that a user may not otherwise know that they could encounter, etc.). In this regard, the computer systems and computer-implemented methods described herein advantageously allow individuals to assess safety-conscious routes using information (e.g., travel characteristics) associated with themselves and/or other travel conditions that a user would otherwise have no way of knowing about/anticipating encountering, alone or in combination with their own driving characteristics (e.g., travel tendencies, etc.), as described herein.

Further, the computer systems and computer-implemented methods described herein may be configured to provide individuals with protective services (e.g., coverage, etc.). For example, as a benefit or reward for choosing to travel with certain characteristics (e.g., along a safe route, historically along safe routes, with safe driving tendencies, etc.) the computer systems and computer-implemented methods described herein may provide a benefit to a user or operator (e.g., a discount, a cost reduction, an increase or expansion in coverage, an increase in duration of coverage of a policy, etc.).

Exemplary Travel Services System with Transportation System

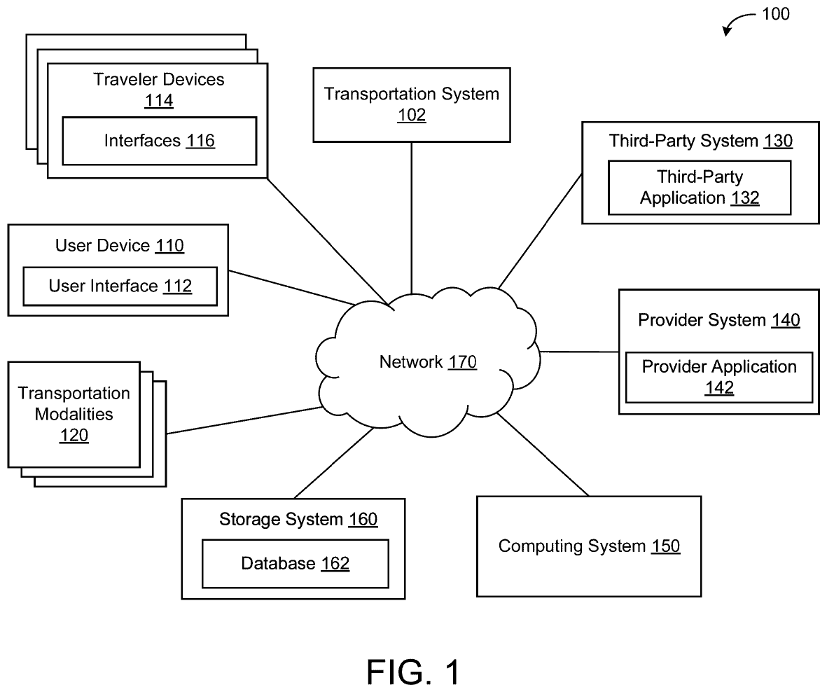

Referring to FIG. 1, a block diagram of an exemplary travel services computer system, shown as travel services system 100, is shown, according to some embodiments. The travel services system 100 may include a transportation computer system, shown as transportation system 102, a user device 110 having a user interface 112, at least one traveler device having user interfaces, shown as traveler devices 114 having interfaces 116, and at least one transportation modality, shown as transportation modalities 120. The travel services system 100 may also include a third-party system 130 having a third-party application 132, a provider system 140 having a provider application 142, and a computing system 150. The travel services system 100 may also include a storage system 160 having a database 162. The components of the travel services system 100 may be connected, or in wired or wireless communication, via a network 170. It should be noted that the number and type of components shown is merely illustrative and, in certain embodiments, implementations of the travel services system 100 may have additional, fewer, and/or different components than those illustrated in FIG. 1, including those mentioned elsewhere herein.

As will be discussed in greater detail below, the transportation system 102 may be configured to generate and/or provide (such as visually or audibly via one or more computing devices) one or more transportation recommendations. For example, the transportation system 102 may be configured to receive a transportation request, and may identify (e.g., using the transportation request) a first geographic location and a second geographic location. For example, the transportation system 102 may receive a transportation request associated with a user traveling to work, and may identify a first location (e.g., a user's home or apartment, etc.) and a second location (e.g., a user's work, a place of business, a coffee shop, etc.) using the request.

In some implementations, the transportation system 102 may also be configured to determine, using the first location and the second location, a plurality of routes between the first location and the second location. The transportation system 102 may identify one or more of the plurality of routes, for example using available transportation options (e.g., a transportation modality). For example, the transportation system 102 may identify one or more routes available for travel using a vehicle (e.g., owned or operated by a user, etc.). In some embodiments, the transportation system 102 may identify one or more routes available for travel using public/private transportation (e.g., a bus, train, ride share service, taxi, vehicle, plane, boat, etc.), an alternative mode of transportation (e.g., a bicycle, walking, scooter, etc.), and/or a combination thereof.

In certain implementations, the transportation system 102 may also be configured to receive travel data. For example, the transportation system 102 may be configured to receive travel data associated with the user. As discussed herein, travel data may include travel-related information associated with the user (e.g., geolocation and/or telematics data, historic and/or current travel characteristics of the user, including, for example, a tendency to travel at a proper speed and/or otherwise obey a posted speed limit, a tendency to accelerate/decelerate as required, a tendency to travel at a reasonable following distance from other vehicles, a tendency to follow proper rules of the road and street signs, a tendency to obey stop signs, etc.). As also described herein, the travel data may include travel-related information associated with travel conditions along one or more routes (e.g., road elements along a route, common traffic density information along a route, common travel tendencies of travelers along a route, common travel tendencies or characteristics of one or more travelers along a route, for example one or more travelers the user may encounter while traveling, etc.).

In some implementations, the transportation system 102 may generate a risk score (e.g., a safety index, a safety score, a safety impact score, etc.). The risk score may indicate an estimated safety impact (e.g., risk, etc.) of choosing to travel along one or more associated routes, for example based upon the travel characteristics of the user and/or one or more travel conditions the user may encounter along each of the associated routes. In some implementations, the transportation system 102 may be configured to generate a risk score for each of the plurality of routes. For example, the transportation system 102 may generate four risk scores for four different routes available between an individual's home and work. As an illustrative example, the transportation system 102 may generate a first risk score for a first route that involves the user having to merge across three lanes of traffic in order to exit, a second risk score for a second route that involves the user encountering a roundabout, a third risk score associated with a third route than involves the user encountering routine commuters driving at above-posted speeds and/or frequently changing lanes, and a fourth risk score for a fourth route that involves the user encountering higher-than normal traffic along a freeway that is under construction.

As described herein, in some embodiments the transportation system 102 may be configured to generate a risk score for each of the plurality of routes, for example based upon travel data associated with the user (e.g., historic driving tendencies, current driving characteristics, etc.). As an illustrative example, the transportation system 102 may generate a first risk score for a first route that involves a user having to merge across three lanes of traffic based upon historical travel data indicating that the user tends to drive cautiously when merging, a second risk score for a second route that involves the user encountering a roundabout based upon historical travel data indicating that the user tends to drive more cautiously when traveling around roundabouts, a third risk score associated with a third route than involves the user encounter driving at above-posted speeds and/or frequently changing lanes based upon historic travel data indicating the user tends to travel at posted speeds and/or does not frequently change lanes, and a fourth risk score for a fourth route that involves the user encountering higher-than normal traffic along a freeway that is under construction based upon current travel data indicating that the user is currently driving more cautiously than normal when traveling in construction.

In some implementations, the transportation system 102 may generate a user interface providing the risk scores. For example, the transportation system 102 may generate a user interface that includes one or more indicators (e.g., an estimated risk score, an estimated safety index, an estimated safety impact, etc.) associated with the risk scores of one or more of the plurality of routes. In some embodiments, and as described herein, the transportation system 102 may provide the score data with one or more policy parameters (e.g., an insurance policy parameter, etc.). As described herein, the one or more policy parameters may be associated with a risk score, choosing to travel along a route, travel characteristics (e.g., historical choices to travel along certain routes, historical travel tendencies, etc.), and/or any other suitable information. In some implementations, the one or more policy parameters is/are provided as a benefit or reward (e.g., a discount, a cost reduction, an increase or expansion in coverage, an increase in duration of coverage of a policy, etc.), for example for choosing to travel with certain characteristics (e.g., along an associated route, with safe driving characteristics, etc.).

In certain implementations, the transportation system 102 may select a transportation recommendation. For example, the transportation system 102 may select a recommended route from the plurality of routes using the risk scores of the plurality of routes. In certain embodiments, the recommended route may be selected based upon an associated risk score indicating a lowest estimated safety impact (e.g., compared to the estimated safety impacts of the plurality of routes). For example, the transportation system 102 may recommend a user travel to work along a less efficient route that involves encountering routine commuters driving along a posted detour at posted speed limits, compared to relatively more efficient routes that involve the user encountering inexperienced drivers and/or higher-than normal traffic or higher-than normal travel speeds, for example because of a lower estimated safety impact (e.g., risk, potential damage, potential injury, etc.) of the less efficient route (e.g., based upon the user being more comfortable with traveling at posted speeds, traveling more cautiously in high density travel conditions, etc.).

In certain implementations, the transportation system 102 may generate a user interface providing the transportation recommendation. The transportation system 102 may provide the transportation recommendation with one or more indicators (e.g., an estimated risk score, an estimated safety index, an estimated safety impact, etc.). In some embodiments, the transportation system 102 may provide the transportation recommendation with one or more policy parameters (e.g., an insurance policy parameter, etc.). As described herein, the one or more policy parameters may be associated with a risk score, choosing to travel along a route, a transportation recommendation, travel characteristics (e.g., historical choices to travel along certain routes, historical travel tendencies, etc.) and/or any other suitable information. In some implementations, the one or more policy parameters is/are provided as a benefit or reward (e.g., a discount, a cost reduction, an increase or expansion in coverage, an increase in duration of coverage of a policy, etc.), for example for choosing to travel with certain characteristics (e.g., along an associated route, with safe driving characteristics, etc.). In certain implementations, the one or more policy parameters is/are another suitable benefit and/or reward (e.g., a consistent and/or safe traveling speed discount, a safe driving discount, a travel congestion reduction discount, etc.).

Referring back to FIG. 1, according to certain embodiments, components of the travel services system 100 may be configured to communicate (e.g., via the network 170). For example, components of the travel services system 100 may be configured to communicate with the transportation system 102. Information and/or data associated with the user device 110, the traveler devices 114, and/or the transportation modalities 120 may be communicated to the transportation system 102 (e.g., via the network 170). Information and/or data associated with the third-party system 130 and/or the provider system 140 may also be communicated to the transportation system 102 (e.g., via the network 170). Information and/or data associated with the computing system 150 and/or the storage system 160 may also be communicated to the transportation system 102 (e.g., via the network 170).

In some embodiments, the transportation system 102 may be implemented using cloud computing services. The transportation system 102 may be implemented using one or more computing devices, for example operating alone and/or in combination. In some implementations, the transportation system 102 may be implemented using computing architectures like multiple distributed servers, and/or similar computing devices and/or systems. In certain embodiments, the transportation system 102 may be another suitable computing system, for example distributed across multiple systems or devices (e.g., which may be located within a single building or facility, or distributed across multiple different buildings or facilities), or within a single computer (e.g., one server, housing, etc.). All such implementations are contemplated herein.

As shown, the transportation system 102 may be configured to communicate with the user device 110. The user device 110 may include one or more human-machine interfaces or client interfaces, shown as user interface 112 (e.g., a graphical user interface, a text-based computer interface, a client-facing web service, a web service that provides pages to a web client, etc.), for example for controlling, viewing, and/or otherwise interfacing with the transportation system 102. The user device 110 may include a personal mobile computing device (e.g., a smart phone, a tablet, a mobile device, a wearable, smart glasses, a smart watch, etc.). The user device 110 may include a computer workstation, a client terminal, a remote or local interface, and/or any other user interface device. The user device 110 may be a stationary terminal (e.g., a desktop computer, a laptop computer, a tablet, or another suitable non-mobile device).

In some implementations, information/data associated with the user device 110 may be communicated to the transportation system 102. In certain embodiments, the user device 110 itself may be configured to communicate information/data to the transportation system 102. In some embodiments, a device coupled to the user device 110, a component implemented with the user device 110, an application or program housed and/or executed on the user device 110, and/or another suitable component associated with the user device 110 may be configured to communicate information/data to the transportation system 102.

In certain embodiments, the transportation system 102 may be configured to receive a transportation request. For example, the user device 110 (e.g., in response to an input from a user or operator, etc.) may communicate a transportation request to the transportation system 102. The transportation request may identify a geographic location, for example a geographic location a user or operator desires to travel to and/or from. For example, the transportation request may identify a user's work, a location of a gathering a user desires to attend, and/or a location of a grocery store that a user frequently visits.

In some embodiments, the transportation request may identify a plurality of geographic locations. For example, the transportation request may identify a first geographic location (e.g., a location a user desires to travel from, for example their home); a second geographic location (e.g., a location a user desires to travel to, for example work); and/or an additional geographic location, for example a location a user or operator desires to avoid (e.g., due to construction, an accident, inclement weather conditions, etc.), a location a user or operator desires to stop (e.g., a grocery store to run an errand, a school or daycare to pick up a child, a hospital or care giving facility to visit a relative, etc.), a location a user or operator desires to travel through or visit (e.g., a seasonal landmark, a sightseeing event, etc.), and/or another suitable location.

In some implementations, the transportation request may include additional information (e.g., a time associated with initiation of the request, a time associated with a communication of the request, a device identifier associated with a device that initiates and/or communicates the request, an application/user identifier associated with a user or operator of an application that initiates and/or communicates the transportation request, etc.).

In some implementations, the transportation request may include a preference, for example a travel preference (e.g., a preferred departure time, total travel time, a preferred travel route, etc.). The transportation request may also include a preferred type of transportation (e.g., a vehicle operated by the user, a ride share vehicle, bus, etc.) and/or other similar transportation related preferences and/or aversions. The transportation request may also include a safety impact preference, for example a preference to minimize/reduce an estimated risk associated with a travel event (e.g., a route, etc.), and/or other similar preferences (e.g., a preference to avoid high traffic areas, areas with construction, areas with road or lane closures, areas with emergency or weather-related events, certain road elements, for example large bridges, overpasses, or roundabouts, etc.). In certain implementations, the user device 110 may also be configured to store and/or provide (e.g., to the transportation system 102) historical data associated with transportation requests and/or preferences, for example to identify trends or tendencies (e.g., common, or repeated locations, routes, travel times, preferences, etc.) associated with a user or operator.

In certain implementations, the transportation system 102 may also be configured to receive information/data associated with the user device 110. For example, the user device 110 may communicate (e.g., automatically, or in response to an input from a user or operator, etc.) geolocation and/or telematics data (e.g., acceleration or deceleration data, turning or cornering data, heading data, speed data, GPS, and/or other movement or telematics related data, etc.) to the transportation system 102. For example, the user device 110 may communicate information associated with a location of the user device 110, a speed and/or direction of movement of the user device 110, a starting/ending location of the user device 110 during a travel event, and/or other similar geolocation and/or telematics data. The user device 110 may communicate real-time and/or historic geolocation and/or telematics data associated with the user device 110 to the transportation system 102.

In some embodiments, a user or operator may opt-in to sharing geolocation and/or telematics data with the transportation system 102, such that the user device 110 communicates geolocation and/or telematics data to the transportation system 102 at predetermined times (e.g., hourly, daily, weekly, etc.), in predetermined locations (e.g., in an identified geofenced location, for example when “at home” or “at work,” etc.), during use of predetermined applications, services, and/or interfaces associated with the user device 110 (e.g., a navigation/map application, a transportation or rental application, etc.), and/or other similar scenarios.

The transportation system 102 may also be configured to receive information/data associated with a user or operator associated with the user device 110. For example, the user device 110 may communicate (e.g., automatically, or in response to an input from a user or operator, etc.) information associated with a user or operator associated with one or more applications (e.g., housed or executed on the user device 110). In certain embodiments, the user device 110 may communicate transportation or travel information associated with a user or operator, for example from a travel application (e.g., associated with a navigation/map application, etc.), a ride-share application, a rental application (e.g., associated a vehicle, bike, scooter, etc. rental entity), and/or similar travel applications.

For example, the user device 110 may also communicate information associated with trends and/or tendencies of a user or operator. For example, the user device 110 may communicate travel tendencies and/or characteristics of a user or operator. The travel tendencies and/or characteristics may be associated with historic travel tendencies and/or characteristics, and/or current (e.g., real-time, or near real-time, etc.) travel characteristics and/or tendencies. For example, the user device 110 may communicate travel tendencies and/or characteristics, including, for example a tendency to travel at a proper speed and/or otherwise obey the posted speed limit, a tendency to accelerate/decelerate as required, a tendency to travel at a reasonable following distance from other vehicles, a tendency to follow proper rules of the road and street signs, a tendency to obey stop signs, etc. In some embodiments, the travel tendencies and/or characteristics are evaluated relative to the user and/or other travelers (e.g., historic, common, similarly situated travelers, etc.). For example, the travel tendencies and/or characteristics may include a tendency to drive cautiously when merging or changing lanes, a tendency to drive cautiously (and/or avoid) certain road elements (e.g., roundabouts, large bridges, overpasses, etc.), a tendency to drive cautiously under certain travel conditions (e.g., high density traffic; wet, icy, snowy, windy, foggy, etc.), and/or other suitable travel characteristics. In some instances, the user device 110 may also communicate information and/or data associated with a rating (e.g., a ride share rating, a driver rating, etc.) and/or other tendencies or trends of a user or operator while traveling (e.g., a level of engagement with the user device 110, a level of engagement with a microphone or camera of the user device 110, use of maps or other direction-related applications, etc.), as described here.

The transportation system 102 may also be configured to receive information associated with a product or service associated with a user or operator of the user device 110. For example, the user device 110 may communicate (e.g., automatically, or in response to an input from a user or operator, etc.) information relating to a vehicle associated with the user or operator (e.g., year, make, model, availability of autonomous driving, anti-lock braking and/or other safety capabilities, etc.). The user device 110 may communicate information relating to the health, safety, or wellness associated with a user or operator (e.g., from a health or fitness application, from a safety or crime prevention related application, etc.). According to some embodiments, the user device 110 may be configured to communicate historic information/data associated with a user or operator to the transportation system 102, as well as information in real-time or near real-time.

The transportation system 102 may also be configured to receive data or information gathered and/or captured by the user device 110. For example, the user device 110 may include a microphone or camera (e.g., for capturing audiovisual information). The user device 110 may capture (e.g., automatically, and/or in response to an input by a user or operator) audiovisual data around the user device 110, for example while a user or operator is in transit. The user device 110 may communicate the audiovisual information to the transportation system 102. In some embodiments, the user device 110 may be configured to communicate audiovisual information (e.g., voice memos, voicemails, images, videos, etc.) stored on the user device 110 to the transportation system 102.

As shown, and as will be described in greater detail below, the transportation system 102 may be configured to communicate with the third-party system 130. The transportation system 102 may be configured to receive transportation and/or travel related information/data associated with the third-party system 130 (e.g., historic travel data, current travel data, for example data obtained in real-time or near real-time, etc.). For example, the third-party system 130 may be associated with a transportation or navigation entity (e.g., a navigation application, a map application, etc.). The transportation system 102 may be configured to receive map and/or navigation related information from the third-party system 130.

For example, the transportation system 102 may be configured to receive map and/or navigation related information, including transportation-related layouts and/or geometries (e.g., lane layouts, interchange layouts, on/off ramp layouts, road/rail intersection layouts, lane or shoulder geometries, road or median geometries, etc.). In some implementations, the map and/or navigation related information includes information associated with transportation elements (e.g., bridges, overpasses, interchanges, high-occupancy lanes, roundabouts, cross-walks, bike lanes, etc.). In certain implementations, the map and/or navigation related information includes information surrounding potential encounters associated with transportation elements (e.g., deer or cattle crossing, farm machinery crossing, truck crossing, hill warning, truck rollover warning, rail crossing, roadwork or workers ahead, lodging warning, hospital or emergency medical services area, picnic or hiking area, all-terrain vehicle area, snowmobile trail, playground or school zone, etc.).

In some embodiments, the transportation system 102 may be configured to receive map and/or navigation related information, including travel and/or transportation related information (e.g., historic travel information, current travel conditions, etc.). For example, the travel and/or transportation related information may include traffic densities (e.g., historic, current, associated with a highway or intersection, etc.), travel speeds (e.g., relative to posted speeds, related to common or frequent travelers, etc.), frequency of lane changes, frequency of acceleration/deceleration events, accident information, construction information, weather related information (e.g., visibility conditions, road conditions, including wet, icy, snowy, etc. conditions, etc.) and/or other suitable travel and/or transportation related information. As will be described herein, in some embodiments the transportation system 102 may use travel data (e.g., associated with the third-party system 130, etc.), alone and/or in combination with other travel data described herein (e.g., associated with a user or individual, etc.), for example to generate risk scores associated with a plurality of routes and/or provide a travel recommendation (e.g., a recommended route, etc.) to reduce and/or prevent potential risks associated with the individual traveling along a route under associated travel conditions.

Referring still to FIG. 1, as shown the transportation system 102 may also be configured to communicate with the traveler devices 114. Like the user device 110, the traveler devices 114 may include one or more human-machine interfaces or client interfaces, shown as interfaces 116 (e.g., a graphical user interface, a text-based computer interface, a client-facing web service, a web service that provides pages to a web client, etc.), for example for controlling, viewing, and/or otherwise interfacing with the transportation system 102. The traveler devices 114 may include a personal mobile computing device (e.g., a smart phone, a tablet, a mobile device, a wearable, smart glasses, a smart watch, etc.), a computer workstation, a client terminal, a remote or local interface, and/or any other user interface device. The traveler devices 114 may also be a stationary terminal (e.g., a desktop computer, a laptop computer, a tablet, or another suitable non-mobile device).

In some implementations, the traveler devices 114 are associated with one or more travelers and/or entities (e.g., individuals or users, travel service providers or entities, for example taxis, ride-share applications, etc.). In certain implementations, the traveler devices 114 are associated with the user device 110. For example, the user device 110 and the traveler devices 114 (e.g., or associated users or operators, etc.) may be enrolled and/or participate in a program (e.g., a transportation program, a coverage program, etc.), for example associated with an entity (e.g., a transportation entity, a coverage entity, etc.). While the traveler devices 114 are shown to include a plurality of traveler devices 114, it is contemplated herein that the travel services system 100 may include one traveler device 114.

In some implementations, information/data associated with the traveler devices 114 may be communicated to the transportation system 102. In certain embodiments, the traveler devices 114 themselves may be configured to communicate information/data to the transportation system 102. In some embodiments, devices coupled to the traveler devices 114, a component implemented with the traveler devices 114, an application or program housed and/or executed on the traveler devices 114, and/or another suitable component associated with traveler devices 114 may be configured to communicate information/data to the transportation system 102.

As described herein, the transportation system 102 may be configured to receive information/data associated with the traveler devices 114. For example, the traveler devices 114 may communicate (e.g., automatically, or in response to an input from a user or operator, etc.) geolocation and/or telematics data (e.g., acceleration or deceleration data, turning or cornering data, heading data, speed data, GPS, and/or other movement or telematics related data, etc.) to the transportation system 102. For example, the traveler devices 114 may communicate information associated with a location of the traveler device 114, a speed and/or direction of movement of the traveler device 114, a starting/ending location of the traveler device 114 during a travel event, and/or other similar geolocation and/or telematics data. The traveler devices 114 may communicate real-time and/or historic geolocation and/or telematics data associated with the traveler devices 114 to the transportation system 102. In some implementations the geolocation and/or telematics data in geolocation and/or telematics data of a transportation modality (e.g., a vehicle, etc.) associated with the traveler device 114, as described herein.

In certain embodiments, a user or operator associated with the traveler device 114 may opt-in to sharing geolocation and/or telematics data with the transportation system 102. For example, the traveler devices 114 may communicate geolocation and/or telematics data to the transportation system 102 at predetermined times (e.g., continuously, hourly, daily, weekly, etc.), in predetermined locations (e.g., in an identified geofenced location, for example when leaving “home” or “work,” etc.), during use of predetermined applications, services, and/or interfaces associated with the traveler devices 114 (e.g., a navigation/map application, a transportation or rental application, etc.), and/or other similar scenarios.

In certain embodiments, the traveler devices 114 may communicate geolocation and/or telematics data in response to an input (e.g., a call, request, pull, notification, etc.). For example, in response to receiving a transportation request (e.g., from the user device 110, etc.), the transportation system 102 may communicate with the traveler devices 114 (e.g., via the network 170). The communication may include a call or request to the traveler devices 114, for example to provide geolocation and/or telematics data (e.g., to the transportation system 102). In this regard, the transportation system 102 may be configured to communicate with the traveler devices 114 (e.g., in response to a transportation request, etc.), for example to determine a location and/or telematic information associated with the traveler devices 114. As described herein, in some embodiments, the location and/or telematic information associated with the traveler devices 114 may be used to determine a set of travelers or individuals (e.g., associated with the traveler devices 114, etc.) that a user (e.g., associated with the user device 110, etc.) may encounter when traveling along any and/or all of the plurality of potential routes.

In certain embodiments, the transportation system 102 may also be configured to receive information/data associated with a user or operator associated with the traveler devices 114. For example, the traveler devices 114 may communicate (e.g., automatically, or in response to an input from a user or operator, etc.) information associated with a user or operator associated with one or more applications (e.g., housed or executed on the traveler devices 114). In some implementations, the traveler devices 114 may communicate transportation or travel information associated with a user or operator, for example from a travel application (e.g., associated with a navigation/map application, a transportation provider, etc.), a ride-share application, a rental application (e.g., associated a vehicle, bike, scooter, etc. rental entity), and/or similar travel applications.

The traveler devices 114 may also be configured to communicate information associated with trends or tendencies of a user or operator. For example, the traveler device 114 may communicate a rating (e.g., a ride share rating, a driver rating, etc.), tendencies of a user or operator to comply with rules or regulations while traveling (e.g., ride share or rental rules, driving rules, for example a tendency to travel at a proper speed and/or otherwise obey the posted speed limit, a tendency to accelerate/decelerate as required, a tendency to travel at a reasonable following distance from other vehicles, a tendency to follow proper rules of the road and street signs, a tendency to obey stop signs, etc.), and/or other tendencies or trends of a user or operator while traveling (e.g., a level of engagement with the traveler device 114, a level of engagement with a microphone or camera of the traveler device 114, use of maps or other direction-related applications, etc.).

The transportation system 102 may also be configured to receive information associated with a product or service associated with a user or operator of the traveler devices 114. For example, the traveler devices 114 may communicate (e.g., automatically, or in response to an input from a user or operator, etc.) information relating to a transportation modality associated with the user or operator (e.g., a vehicle year, make, model, availability of autonomous driving, other safety-related features or abilities, etc.). The traveler devices 114 may also communicate information relating to the health, safety, and/or wellness associated with a user or operator (e.g., from a safety or crime prevention related application, etc.). In some embodiments, the traveler devices 114 are configured to communicate policy related information to the transportation system 102 (e.g., a history of repairs and/or maintenance performed on the transportation modality, a history of claims and/or requests associated with transportation modality and/or a user or operator of the traveler device 114, and/or other suitable information or data, etc.) In certain embodiments, the traveler devices 114 may be configured to communicate historic information/data associated with a user or operator to the transportation system 102, as well as information in real-time.

In some implementations, the transportation system 102 may also be configured to receive data or information gathered and/or captured by the traveler devices 114. For example, the traveler devices 114 may include a microphone or camera (e.g., for capturing audiovisual information). The traveler devices 114 may capture (e.g., automatically, and/or in response to an input by a user or operator) audiovisual data around the traveler device 114 (e.g., while a user or operator is in transit, following a request or call, etc.). The traveler devices 114 may communicate the audiovisual information to the transportation system 102, for example in real-time (e.g., in real-time, following a request or call to provide geolocation and/or telematics data, etc.). In certain embodiments, the traveler devices 114 may be configured to communicate audiovisual information (e.g., voice memos, voicemails, images, videos, etc.) stored on the traveler devices 114 to the transportation system 102.

As shown, information/data associated with the transportation modalities 120 may be communicated to the transportation system 102. In some embodiments, the transportation modalities 120 may be configured to communicate information/data to the transportation system 102. In some implementations, a device coupled to, a system or device monitoring a transportation modality, a device obtaining data from and/or regarding a modality, and/or another suitable system or device associated with a modality may be configured to communicate information/data to the transportation system 102. In certain embodiments, the transportation modalities 120 may include at least one transportation modality or mode (e.g., also referred to herein as a transportation modality 120).

In certain embodiments, at least one of the transportation modalities 120 is associated with at least one traveler device 114. For example, the transportation modality 120 may be associated with a user or operator associated with the traveler device 114. In some embodiments, the traveler device 114 (e.g., associated with a user or operator of the transportation modality 120, etc.) may be configured to communicate information/data associated with the transportation modality 120 to the transportation system 102. For example, the traveler device 114 may be configured to communicate geolocation and/or telematics data associated with the transportation modality 120 (e.g., as well as the traveler device 114, etc.) to the transportation system 102. In this regard, in some implementations information/data associated with a user or operator, the associated traveler device 114, and/or the associated transportation modality 120 may be communicated to the transportation system 102 (e.g., via the traveler device 114, the transportation modality 120, and/or a combination thereof). Similarly, in certain embodiments, at least one of the transportation modalities 120 is associated with the user device 110 (e.g., associated with a user or operator of the user device 110, etc.).

In some embodiments, the transportation modality 120 may be or be associated with a vehicle (e.g., a car, truck, etc.). As described herein, the vehicle may be owned and/or operated by one or more vehicle users (e.g., a user or operator associated with the user device 110, a user or operator associated with the traveler device 114, etc.). The vehicle may be any kind of vehicle, including cars, trucks, user-driven or user operated vehicles, self-driving vehicles, autonomous vehicles, semi-autonomous vehicles, motorcycles, recreational vehicles (RVs), all-terrain vehicles (ATVs), snowmobiles, boats, flying taxis, planes, and/or other similar personal mobility vehicles.

In some implementations, the transportation modality includes public or private transportation (e.g., bus, train, trolley, tram, coaches, metro, light rail, monorail, rapid rails, subway, etc.), a micromobility vehicle (e.g., a lightweight transportation vehicle, for example a bicycle or scooter, an electronic transportation vehicle, a vehicle used for short-term or short-trip travel, a vehicle that travels below a predetermined speed, for example 10, 15, or 20 miles per hour, etc.), a shared vehicle, an airplane, and/or another suitable form of transportation (e.g., a boat, ferry, taxi, gondola, etc.). Further, the transportation modality 120 may include various alternative forms of transportation, for example walking, running, rollerblading, skateboarding, ice skating, skiing, or other alternative forms of transportation.

In certain embodiments, the transportation system 102 may be configured to receive information/data associated with the transportation modality 120. For example, the transportation system 102 may receive geolocation and/or telematics data associated with the transportation modality 120. In some embodiments, the transportation system 102 may be configured to receive transportation related metrics associated with the transportation modality 120, for example maintenance information (e.g., oil changes, tire rotations, etc.), upcoming or outstanding repair information (e.g., brake replacement, tire replacement, etc.), and/or additional characteristics associated with the transportation modality 120 (e.g., whether the vehicle includes sensors or alarms, anti-lock braking, traction control, electronic stability control, acceleration slip regulation, cruise control, autonomous cruise control, lane-keep assist systems, driver monitoring systems, adaptive headlamp control, collision avoidance systems, parking assist systems, blind spot monitoring, navigation systems, etc.). In certain implementations, the transportation related metrics include fuel efficiency characteristics, emissions information, electrical or ecological efficiency characteristics, and/or other suitable information associated with the transportation modality 120, which may be used to assess a safety impact (e.g., a risk score, a safety score, etc.) associated with the transportation modality 120.

In some implementations, the transportation system 102 may receive historic transportation related information associated with the transportation modality 120. For example, the transportation system 102 may receive information relating to historic travel locations/destinations, historic travel times, average number of turns during a travel event, average number of stops during a travel event, average number of detours or course changes during a travel event, travel speed (e.g., average speed) and/or travel movement (e.g., acceleration, deceleration, etc.) data, fuel efficiency (e.g., average fuel efficiency) data, and/or other suitable transportation related information associated with the transportation modality 120.

Additionally or alternatively, the transportation system 102 may be configured to receive audiovisual information (e.g., images, videos, audio recordings, sensor data, etc.) associated with the transportation modality 120. In some embodiments, the audiovisual information may be used to assess the transportation modality 120 (and/or associated users or operators, etc.), for example to verify transportation related metrics or trends (e.g., number of turns, average speed, etc.); user or operator characteristics or tendencies (e.g., ratings, tendencies to comply with travel regulations, safety standards, etc.); and/or other suitable transportation information (e.g., a transportation recommendation, a recommended route, a compliance with a travel recommendation and/or an associated safety or risk score, etc.).

As shown, the transportation system 102 may be configured to receive information/data associated with the third-party system 130. The third-party system 130 may include a third-party application 132. While the travel services system 100 is shown to include one third-party system 130, it is contemplated herein that the travel services system 100 may include a plurality of third-party systems 130. In certain embodiments, the transportation system 102 may be configured to receive transportation and/or travel related information/data associated with the third-party system 130. Additionally or alternatively, the transportation system 102 may be configured to receive environmental (e.g., weather, etc.), social (e.g., crime, etc.), and/or ecological information associated with the third-party system 130.

In some implementations, and as discussed briefly herein, the third-party system 130 may be associated with a transportation or navigation entity. For example, the third-party system 130 may be associated with a navigation and/or map application. The transportation system 102 may (e.g., automatically, and/or in response to an input from a user or operator) receive navigation and/or map information associated with the third-party system 130. For example, the transportation system 102 may receive map and/or navigation information, including street names, roads/crossroad layouts, traffic density indicators, accident and/or construction notifications, express lane indicators, high occupancy vehicle lane indicators (e.g., a lane for vehicles with multiple occupants, etc.), and/or other suitable map and/or navigation information, as described herein.

In some embodiments, the transportation system 102 may be configured to receive historic information associated with the navigation information, for example historic traffic and/or accident trends along associated roads and/or at intersections, historic travel speeds or times along associated roads (e.g., including trends associated with reduced/increased speeds, occurrences of stops/starts, etc.), and/or other historic navigation related information, as described herein.

In certain embodiments, the third-party system 130 may be associated with a public entity (e.g., a city, a town, a village, a municipality, and/or another suitable government entity), a transportation network company (e.g., a ride-share service and/or a transportation rental service, etc.), a public transportation entity, a private transportation entity (e.g., a taxi service, etc.), and/or another suitable entity (e.g., an entity associated with weather, climate, and/or environmental information; an entity associated with crime and/or safety information; etc.). The transportation system 102 may be configured to receive additional map, navigation, and/or travel information associated with the third-party system 130 (e.g., trails, paths, sidewalks, etc.; bus timetables/routes, train timetables/routes, subway timetables/routes, etc.; airplane timetables/routes, shuttle timetables/routes, taxi timetables/routes, etc.). The transportation system 102 may also be configured to receive historic transportation and/or travel related information associated with the third-party system 130.

As shown, information/data associated with the provider system 140 may also be communicated to the transportation system 102. In some embodiments, the provider system 140 may communicate information/data to the transportation system 102. In certain implementations, a device coupled to, a component implemented with the provider system 140, an application or program housed and/or executed on the provider system 140, and/or another suitable component associated with the provider system 140 may be configured to communicate information/data to the transportation system 102.

The provider system 140 may include a provider application 142. In some embodiments, the provider system 140 may be associated with a company or entity that provides protective services (e.g., insurance, etc.) to a user or operator (e.g., a user or operator associated with the user device 110, the traveler device 114, etc.), a company or service provider (e.g., OEM or a provider associated with the third-party system 130), and/or over one or more products or services (e.g., associated with the transportation modality 120, etc.). In certain embodiments, the provider system 140 may include the transportation system 102, as described herein. The provider system 140 may be configured to communicate with the transportation system 102 (and/or the user device 110, the traveler device 114, the transportation modality 120, etc.), for example to provide one or more transportation recommendations and/or policy parameters.

In some implementations, the provider system 140 may be configured to communicate information/data associated with one or more policy parameters. For example, the provider system 140 may be configured to analyze information/data associated with travel events and/or transportation events (e.g., occurrences of hazardous or damaging events, occurrences and/or severity of claims associated with travel or transportation events, etc.). The provider system 140 may analyze historic information associated with travel and/or transportation events. In some embodiments, the provider system 140 is configured to utilize natural language processing (NLP) models and/or large language models (LLMs), for example to aggregate and/or otherwise analyze (e.g., process, ingest, etc.) the historic information (e.g., historic claims associated with travel or transportation events, travel areas, environmental conditions, etc.). As described herein, the information/data associated with the travel events and/or transportation events may be communicated to the transportation system 102.

In certain implementations, the transportation system 102 may receive an insurance policy parameter. The provider system 140 may be configured to provide a policy parameter (e.g., to the transportation system 102, to the user device 110, to other components of the travel services system 100, etc.). A policy parameter may refer to a parameter of one or more insurance products (e.g., coverages, policy terms/limits, premiums, deductibles, endorsements, etc.). In certain embodiments, the one or more policy parameters may be selected, generated, and/or offered, for example to provide coverage, supplement and/or increase existing coverage, and/or to provide new coverage. In certain implementations, the provider system 140 may be configured to generate a plurality of policy parameters. For example, the provider system 140 may be configured to provide discounts, rewards, or other benefits responsive to the user opting to select/utilize safer routes, as will be described herein.

In various embodiments, the policy parameters may be selected, generated, and/or offered based upon a policy availability and/or policy source, a policy availability location, and/or additional parameters (e.g., a cost, a time over which the policy is available, a product or service over which the policy is available, a destination range or location over which the policy is available, eligibility requirements, ability to group or bundle different policies or parameters, available discounts or rewards associated with a policy or parameter, etc.).

As noted herein, in some embodiments the transportation system 102 may be configured to receive one or more policy parameters. For example, a policy parameter may be generated (e.g., via the provider system 140) that provides coverage (e.g., over an individual, over a vehicle, over a combination thereof, etc.), for example associated with one or more travel characteristics (e.g., choosing to travel along a selected and/or recommended route, opting to travel with one or more travel characteristics, etc.).

In some embodiments, the one or more policy parameters may be generated using one or more factors. For example, one or more policy parameters may be generated using a risk score (e.g., safety impact, safety impact score, etc.), a safety factor (e.g., a by-peril rating, or a rating based upon one or more parameters or factors described herein for each route), and/or a combination thereof. In some implementations, as a benefit or reward for choosing to travel with certain travel characteristics (e.g., along a recommended route having a lowest risk score, a recommended route having a reduced or lower risk or safety impact score, along a series of routes having a reduced or lower risk or safety impact score, historically traveling along routes that have reduced or lower risk or safety impact scores, etc.), at least one policy parameter may be generated that provides a benefit to a user (e.g., an insurance policy, a discount, a reward, a cost-savings, a cost reduction to an existing policy, an increase in coverage, an increase in duration of coverage of a policy, etc.).

Additionally or alternatively, one or more policy parameters may be generated using a plurality of parameters and/or factors. For example, a policy parameter (e.g., a policy discount or premium, etc.) may be generated, for example based upon a user opting to select and/or utilize a route option (e.g., a safer route option, a safest route option, etc.). The policy parameter may be generated and/or provided using historical parameters and/or factors. For example, as a benefit, discount, or reward for a user selecting (e.g., opting, choosing, etc.) to travel along certain routes (e.g., safer route options, safest route options, etc.) and/or to travel with certain characteristics (e.g., safe driving habits, etc.), a policy parameter may be generated that provides a reward or benefit to the user (e.g., a discount, cost savings, etc.), as described herein.

In certain embodiments, the policy parameters may be generated using one or more parameters and/or factors, for example a base policy (e.g., discount, rate, coverage, etc.), a location rating factor (e.g., city, state, urban location, rural location, etc.), a coverage rating (e.g., availability, amount, term, etc. of coverage), a claim rating factor (e.g., based upon historical claim information associated with a route, a user or operator, a traveler or other individual, etc.), a safety impact discount, a risk rating (e.g., a personal injury risk rating, a liability risk rating, etc. associated with a route, a user or operator, a traveler or other individual or entity, etc.), and/or a combination thereof. As described herein, the one or more policy parameters may be selected and/or generated, for example to provide a benefit or reward (e.g., a premium discount and/or expanded coverage, etc.) to traveling with characteristics (e.g., along a selected route, etc.) associated with a lower estimated damage and/or potential risk (e.g., property damage, personal injury, financial injury, etc.).

In certain embodiments, the policy parameter (e.g., premium, coverage, etc.) may be associated with various forms of coverage of an individual and/or mode of transportation, for example collision coverage, comprehensive coverage, liability coverage, rental and/or travel expense coverage, uninsured and/or underinsured motorist coverage, ride share driver or rider coverage, medical payments coverage, emergency road service coverage, personal injury coverage, incidental injury coverage, micromobility vehicle coverage, and/or other suitable transportation related coverages.

As shown, the transportation system 102 may be configured to communicate with the computing system 150. In some implementations, the computing system 150 may be a cloud-based computing system, for example to provide digital connections between different computing devices and/or systems (e.g., as described herein). The computing system 150 may be a virtual reality (VR) system or augmented reality (AR) system, for example to provide digital connections between a plurality of metadata sources, where the metadata sources are integrated within the VR system or AR system.

In various embodiments, the computing system 150 may be implemented using one or more computing devices, for example operating alone and/or in combination. In some embodiments, the computing system 150 may be implemented using computing architectures like multiple distributed servers, and/or similar computing devices and/or systems. In some implementations, the computing system 150 may be a server (e.g., including a processor coupled to a memory), for example to store and/or recall data and applications within the memory. In certain embodiments, the computing system 150 may be another suitable computing system, for example distributed across multiple systems or devices (e.g., which may be located within a single building or facility, or distributed across multiple different buildings or facilities), or within a single computer (e.g., one server, housing, etc.). All such implementations are contemplated herein.

As shown, the transportation system 102 may be configured to communicate with the storage system 160 (e.g., having the database 162). In some embodiments, the transportation system 102 communicates with the storage system 160, either directly (e.g., via the network 170) or indirectly (e.g., via the user device 110, the transportation modalities 120, etc.). The storage system 160 may include one or more devices (e.g., RAM, ROM, Flash memory, hard disk storage, etc.) for storing data and/or computer code for implementing and/or facilitating the various processes, layers, and/or circuits described herein. The storage system 160 may be or include volatile memory or non-volatile memory, and may include database components, object code components, script components, and/or any other type of information structure for supporting the various activities and information structures described herein.

In certain embodiments, and as will be discussed in greater detail, the transportation system 102 may also be configured to generate data. For example, the transportation system 102 may include components (e.g., a request compiler, an analyzer, a score generator, a score analyzer, a recommendation generator, and/or a database, etc.) that obtain, analyze, process, generate, store, and/or communicate data.

In various embodiments, the transportation system 102 may be configured to receive a transportation request, identify a first location and a second location using the transportation request, and/or determine a plurality of routes between the first location and the second location. The transportation system 102 may also be configured to receive travel data associated with an individual (e.g., historic travel data, current travel data, etc.) and/or travel conditions (e.g., road conditions, road elements along a rout, traffic density information, traveler speed information, a second user the individual may encounter, etc.) along at least one of the plurality of routes. The transportation system 102 may be configured to generate a risk score for each of the plurality of routes using the travel data associated with the individual and/or the travel conditions, the risk score indicating an estimated risk of traveling along the route. In certain implementations, the transportation system 102 is configured to determine a recommended route from the plurality of routes using the risk scores for the plurality of routes, and generate a user interface providing the recommended route.

### Exemplary Transportation Computer System

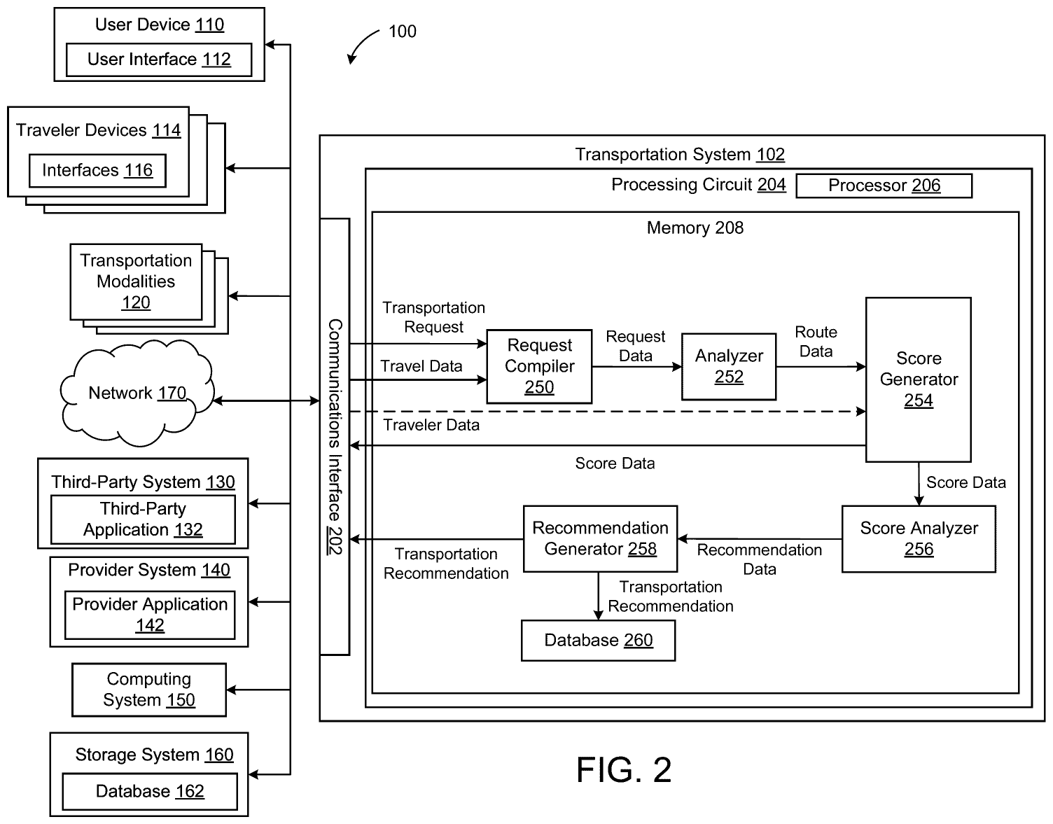

Referring now to FIG. 2, a block diagram of the exemplary transportation system, e.g., the transportation system 102, is shown in greater detail, according to some embodiments. As discussed above, the transportation system 102 may be configured to generate and/or provide one or more transportation recommendations. For example, the transportation system 102 may be configured to receive a transportation request, identify a first location geographic location and a second geographic location associated with the transportation request, and determine a plurality of routes between the first location and the second location. The transportation system 102 may also be configured to receive transportation data and/or travel data (e.g., data associated with the user, data associated with travel conditions, data associated with one or more travelers, etc.), and generate a risk (or non-risk or safety) score (e.g., using the transportation data, the travel data, etc.) for each of the plurality of routes, the risk (or non-risk or safety) score indicating an estimated risk (or non-risk or safety) of traveling along the associated route. The transportation system 102 may select a recommended route from the plurality of routes using the risk (or non-risk or safety) scores (e.g., by identifying a risk (or non-risk or safety) score indicating a lowest estimated safety impact), and generate a user interface providing the recommended route (or otherwise present the recommended route to a user, such as visually or audibly via one or more computing devices, such as mobile devices, AR glasses, VR headsets, voice bots, chatbots, etc.).

As shown in FIG. 2, the transportation system 102 may be communicably connected to the user device 110, the traveler devices 114, the transportation modalities 120, the third-party system 130, the provider system 140, the computing system 150, and/or the storage system 160 (e.g., via the network 170). In certain embodiments, the transportation system 102 may be communicably connected to other suitable systems and/or devices (e.g., via the network 170), including those devices mentioned elsewhere herein. It should be understood that some or all of the components of the transportation system 102, the user device 110, the traveler devices 114, the transportation modalities 120, the third-party system 130, the provider system 140, the computing system 150, the storage system 160, and/or the network 170 may be implemented as art of a cloud-based computing system configured to obtain, process, and/or communicate data from one or more external devices or sources.

Similarly, some, or all, of the components of the transportation system 102, the user device 110, the traveler devices 114, the transportation modalities 120, the third-party system 130, the provider system 140, the computing system 150, the storage system 160, and/or the network 170 may be integrated within a single device or be distributed across multiple separate systems or devices. In some implementations, transportation system 102, the user device 110, the traveler devices 114, the transportation modalities 120, the third-party system 130, the provider system 140, the computing system 150, the storage system 160, and/or the network 170 are components of a controller, a device controller, a field controller, a computer work station, a client device, and/or another system or device that receives, processes, and/or communicates data from/to devices or other data sources.

As shown, the transportation system 102 may include a communications interface 202 and a processing circuit 204 having a processor 206 and a memory 208. The communications interface 202 may include wired or wireless communications interfaces (e.g., jacks, antennas, transmitters, receivers, transceivers, wire terminals, etc.) for communicating data between the transportation system 102 and external systems or devices (e.g., the user device 110, the traveler devices 114, the transportation modalities 120, the third-party system 130, the provider system 140, the computing system 150, the storage system 160, etc.). In some embodiments, the communications interface 202 facilitates communications between the transportation system 102 and one or more external applications and/or interfaces (e.g., the user interface 112, the interfaces 116, the third-party application 132, the provider application 142 etc.), for example to allow a remote user or operator to control, monitor, and/or adjust components of the transportation system 102.

Further, the communications interface 202 may be configured to communicate with external systems and/or devices using any of a variety of communications protocols (e.g., HTTP(S), WebSocket, CoAP, MQTT, etc.) and/or any of a variety of other protocols. Advantageously, the transportation system 102 may obtain, ingest, and process data from any type of system or device, regardless of the communications protocol used by the system or device.

As shown, the transportation system 102 may include the processing circuit 204 having the processor 206 and the memory 208. While shown as single components, it should be appreciated that the transportation system 102 may include one or more processing circuits, including one or more processors and memory.

In certain implementations, the transportation system 102 may include a plurality of processors, memories, interfaces, and/or other components distributed across multiple devices or systems, which are communicably coupled via a network (e.g., the network 170). For example, in a cloud-based or distributed implementation, the transportation system 102 may include multiple discrete computing devices, each of which include a processor 206, memory 208, communications interface 202, and/or other components of the transportation system 102. Tasks performed by the transportation system 102 may be distributed across multiple systems or devices, which may be located within a single building or facility or distributed across multiple buildings or facilities. In other embodiments, the transportation system 102 itself may be implemented within a single computer (e.g., one server, one housing, etc.). All such implementations are contemplated herein.

The processor 206 may be a general purpose or specific purpose processor, an application specific integrated circuit (ASIC), one or more field programmable gate arrays (FPGAs), a group of processing components, or other suitable processing components. The processor 206 may further be configured to execute computer code or instructions stored in the memory 208 or received from other computer readable media (e.g., USB or other local storage, network storage, a remote server, etc.).

The memory 208 may include one or more devices (e.g., memory units, memory devices, storage devices, etc.) for storing data and/or computer code for completing and/or facilitating the various processes described in the present disclosure. The memory 208 may include random access memory (RAM), read-only memory (ROM), hard drive storage, temporary storage, non-volatile memory, flash memory, optical memory, or any other suitable memory for storing software objects and/or computer instructions. In some implementations, the memory 208 may include database components, object code components, script components, and/or any other type of information structure for supporting the various activities and information structures described in the present disclosure. The memory 208 may be communicably connected to the processor 206 via the processing circuit 204, and may include computer code for executing (e.g., by the processor 206) one or more processes described herein. When the processor 206 executes instructions stored in the memory 208, the processor 206 may configure the processing circuit 204 to complete such activities.

As shown, the transportation system 102 (e.g., the memory 208) may include a request compiler 250, a route analyzer, shown as an analyzer 252, a score generator 254, a score analyzer 256, a recommendation generator 258, and a database 260. The following paragraphs describe some of the general functions performed by each of the components 250-260 of the transportation system 102. It should be noted that the number and type of components shown is merely illustrative and, in certain embodiments, implementations of the transportation system 102 may have additional, fewer, and/or different components than those illustrated in FIG. 2.

In some embodiments, the request compiler 250 may be configured to obtain input data, analyze the input data, and/or generate output data to be communicated to other components of the transportation system 102. For example, the request compiler 250 may obtain (e.g., receive, request, pull, call, etc.) a transportation request. The transportation request may be received from an external system or device (e.g., an edge device, the user device 110, etc.), for example via the communications interface 202.

In some implementations, the transportation request is received from an external system or device (e.g., the user device 110, etc.) in response to an input from a user or operator. For example, a user or operator may interact with an application housed and/or hosted by the user device 110 (e.g., a navigation application, etc.), and in response to an input (e.g., received from the user or operator, etc.) the user device 110 may communicate a transportation request to the transportation system 102. In some embodiments, the user device 110 may be configured to communicate a transportation request in response to use and/or interaction with an application, service, and/or interface associated with the user device 110 (e.g., opening or activating a navigation application via the user device 110, etc.). In certain implementations, the user device 110 may be configured to automatically communicate a transportation request to the transportation system 102. In some implementations, another external system or device (e.g., the transportation modality 120 associated with a user or operator of the user device 110, etc.) may be configured to communicate a transportation request to the transportation system 102 (e.g., automatically, or in response to an input by a user or operator, for example powering on the transportation modality 120, operating a navigation application of the transportation modality 120, etc.).

As described herein, in some implementations the transportation request identifies a geographic location. For example, the transportation request may identify a geographic location a user or operator desires to travel to/from (e.g., from home, to work, from work, to a school or daycare facility, etc.). In certain implementations, the transportation request identifies a first geographic location and a second geographic location, for example a first location (e.g., point of departure or trip origination point) a user or operator desires to travel from (e.g., home), and a second location (e.g., destination or arrival point) the user or operator desires to travel to (e.g., work, a grocery store, a location of a gathering, etc.).

In various embodiments, the transportation request may identify additional geographic locations. For example, the transportation request may identify a location (e.g., a geofenced location, etc.) a user or operator desires to avoid (e.g., an area under construction, where an accident has been identified, where inclement weather is predicted to occur or is occurring, a high crime area, etc.), a location a user or operator desires to stop or visit (e.g., a grocery store, gas station, a school or daycare, a hospital or care facility, etc.), a location a user or operator wishes to travel by or through (e.g., a historic landmark, a seasonal sightseeing location, etc.), and/or another suitable location. In some embodiments, the transportation request may include additional request related information (e.g., a time associated with initiation and/or communication of the request, a device, application, and/or user identifier associated with a device or application that initiates and/or communicates the request, etc.).

The transportation request may also identify a preference. For example, the transportation request may include a route preference (e.g., a preference for a route that reduces encountering traffic, reduces stops/starts, avoids a construction event or accident, etc.). In certain embodiments, the transportation request may include a risk or safety impact preference. For example, the transportation request may include a preference to minimize/reduce exposure to potential safety hazards associated with travel along a route. In other embodiments, the transportation request includes another suitable preference (e.g., a preference to minimize/reduce travel time along a route, minimize/reduce an estimated climate impact associated with traveling, etc.). In certain embodiments, the transportation request may include additional travel and/or transportation information (e.g., historic transportation information associated with a user or operator, an additional preference of a user or operator, etc.).

In some implementations, the request compiler 250 may also be configured to obtain (e.g., receive, request, pull, etc.) travel data. The travel data may be received from an external system or device (e.g., an edge device, the user device 110, the traveler devices 114, the transportation modalities 120, the third-party system 130, the provider system 140, the computing system 150, and/or the storage system 160, etc.), for example via the communications interface 202. In certain embodiments, the travel data may be received from one or more components of the transportation system 102 (e.g., the database 260). In this regard, in certain implementations the request compiler 250 may be configured to obtain (e.g., receive, request, pull, etc.) travel data from one or more sources (e.g., an edge device, the user device 110, the traveler devices 114, the database 260, etc.), which may be obtained at one or more periods of time (e.g., obtained in real time from the user device 110, recalled from prior data obtained and/or stored in the database 260, etc.).

As described herein, the travel data may include information associated with a user device (e.g., the user device 110). For example, the travel data may include geolocation and/or telematics data associated with the user device 110 (e.g., a location, a speed or direction of movement, historic and/or real-time geolocation and/or telematics data, etc.). Additionally or alternatively, the travel data may include information associated with a user or operator of a user device (e.g., the user device 110 or other computing device(s), including those mentioned herein).

For example, the travel data may include information associated with travel tendencies and/or characteristics of a user or operator (e.g., associated with the user device 110, etc.). The travel tendencies and/or characteristics may be associated with historic travel tendencies and/or characteristics, and/or current (e.g., real-time, or near real-time, etc.) travel characteristics and/or tendencies. For example, and as described herein, the travel data may include travel tendencies and/or characteristics, including, for example a tendency to travel at a proper speed and/or otherwise obey the posted speed limit, a tendency to accelerate/decelerate as required, a tendency to travel at a reasonable following distance from other vehicles, a tendency to follow proper rules of the road and street signs, a tendency to obey stop signs, etc. In some implementations, the travel tendencies and/or characteristics may include a tendency to drive cautiously when merging or changing lanes, a tendency to drive cautiously (and/or avoid) certain road elements (e.g., roundabouts, large bridges, overpasses, etc.), a tendency to drive cautiously under certain travel conditions (e.g., high density traffic; wet, icy, snowy, windy, foggy, etc.), and/or other suitable travel characteristics, as described herein. Further, the travel data may include information from one or more applications (e.g., a ride-share application, a transportation rental application, and/or another similar travel application, etc.) and/or other suitable information, as described herein.

In some implementations, the travel data may include information associated with a product or service associated with a user or operator of a user device (e.g., the user device 110 or other computing device(s), including those discussed herein.). For example, the travel data may include information relating to a vehicle associated with a user or operator (e.g., maintenance characteristics or history, safety ratings, etc.), and/or transportation characteristics of the vehicle (e.g., an average travel time or distance, an average number of stops or turns, an average speed of travel, etc.). In certain implementations, the travel data may include information collected and/or gathered via a user device (e.g., the user device 110). For example, the travel data may include audiovisual information (e.g., captured via a microphone or camera of the user device 110, and/or captured via a mobile device, AR glasses, VR headset, voice bot, chatbot, wearable, or other computing devices, including those mentioned herein), for example audiovisual (including audio, visual, video, image, and/or graphical information, data, and sensor data) information and related data captured in real-time (e.g., during a travel event) and/or historical audiovisual information and related data.

In some embodiments, the travel data may include information associated with a third-party system (e.g., the third-party system 130). For example, and as described herein, the third-party system 130 may be associated with a travel and/or navigation entity, and the travel data may include navigation and/or map information. For example, the travel data may include transportation-related layouts and/or geometries (e.g., lane layouts, interchange layouts, on/off ramp layouts, road/rail intersection layouts, lane or shoulder geometries, road or median geometries, etc.), information associated with transportation elements (e.g., bridges, overpasses, interchanges, high-occupancy lanes, roundabouts, cross-walks, bike lanes, etc.), information surrounding potential encounters associated with transportation elements (e.g., deer or cattle crossing, farm machinery crossing, truck crossing, hill warning, truck rollover warning, rail crossing, roadwork or workers ahead, lodging warning, hospital or emergency medical services area, picnic or hiking area, all-terrain vehicle area, snowmobile trail, playground or school zone, etc.), and/or other suitable travel or transportation related information described herein (e.g., traffic densities, travel speeds, frequency of lane changes, frequency of acceleration/deceleration events, accident information, construction information, weather related information, etc. associated with one or more roads or travel segments, etc.).

In certain implementations, the travel data may include information associated with one or more traveler devices (e.g., the traveler devices 114, etc.). As described elsewhere herein, the travel data may include geolocation and/or telematics data associated with the traveler devices 114, information associated with a user or operator of the traveler devices 114, information associated with a product or service associated with a user or operator of the traveler devices 114, information obtained and/or gathered via the traveler devices 114, and/or other suitable information associated with and/or relating to the traveler devices 114.

In some embodiments, the travel data may include information associated with a transportation modality (e.g., the transportation modality 120 or transportation mode). For example, the travel data may include information associated with the transportation modality 120 associated with a user or operator associated with a user device (e.g., the user device 110, etc.). As described herein, the travel data may include geolocation and/or telematics data (e.g., historic, real-time, etc.) associated with the transportation modality 120, transportation characteristics of the transportation modality 120 (e.g., travel times, locations, trip lengths, average number of turns, average number of stops/starts, etc.), audiovisual information from the transportation modality 120 (e.g., images, videos, audio, verbal, and/or other data or sensor data, etc.), and/or other suitable information described elsewhere herein.

In some embodiments, and as discussed briefly herein, the travel data may include information associated with a third-party system (e.g., the third-party system 130). For example, the third-party system 130 may be associated with a travel and/or navigation entity, and the travel data may include navigation and/or map information. In certain embodiments, the third-party system 130 may be associated with a public entity (e.g., a city or municipality, and/or a public transportation entity). Additionally or alternatively, the travel data may include map and/or navigation information associated with public transportation entities and/or modalities (e.g., bus or train schedules and routes, etc.), private transportation entities and/or modalities (e.g., flight or shuttle schedules and routes, etc.), and/or transportation network companies and/or modalities (e.g., ride-share service, transportation rental services, users or operators associated with the transportation network companies, etc.).

In some implementations, the travel data may include information associated with a provider system 140. The provider system 140 may be associated with a company that provides protective services (e.g., insurance, etc.) to a user or operator, a company, service provider, and/or one or more products or services. As described herein, the travel data may include one or more policy parameters associated with one or more users, operators, companies, service providers, products, and/or services.

In certain embodiments, travel data may include information associated with a computing system (e.g., the computing system 150) and/or a storage system (e.g., the storage system 160), as described herein. In some embodiments, travel data may be received by the transportation system 102 in real-time and/or at one or more series or intervals (e.g., continuously, hourly, daily, etc., automatically in response to a travel event initiated and/or associated with the user device 110, the traveler devices 114, the transportation modality 120, the third-party system 130, the provider system 140, etc.).

As shown, the request compiler 250 may be configured to obtain input data (e.g., a transportation request, travel data, etc.), analyze the input data, and/or generate output data. For example, the request compiler 250 may be configured to obtain (e.g., receive, request, pull, etc.) a transportation request and/or travel data, analyze (e.g., compile, process, etc.) the data, and generate request data. The request data may be communicated to another component of the transportation system 102 (e.g., the analyzer 252). In certain embodiments, the request data may include data associated with the transportation request and/or travel data, and/or one or more instructions to identify (e.g., generate, determine, etc.) a plurality of transportation options (e.g., a plurality of routes, etc.) associated with the transportation request, as will be discussed below.

In some implementations, the analyzer 252 may be configured to obtain input data, analyze the input data, and/or generate output data to be communicated to other components of the transportation system 102. For example, the analyzer 252 may obtain (e.g., receive, request, pull, etc.) request data, analyze the request data, and/or generate transportation data. In some implementations, the analyzer 252 may be configured to analyze the request data and generate route data. In some implementations, the route data identifies a plurality of routes, for example between the first geographic (or departure) location and the second geographic (or destination or arrival) location.

In some implementations, the analyzer 252 may be configured to determine one or more of the plurality of routes using a preference. For example, the analyzer 252 may be configured to determine one or more routes using a safety impact preference, for example a preference to minimize/reduce an estimated risk associated with a travel event (e.g., a route, etc.). In some implementations, the analyzer 252 may determine one or more routes using a preferred travel characteristic (e.g., a preference to reduce encountering traffic, reduce stops/starts, reduce left turns, reduce curves, reduce hills, avoid an accident and/or a construction event, etc.). In certain embodiments, the analyzer 252 may determine one or more routes using an available transportation modality (e.g., a vehicle owned or operated by a user or operator, etc.), a travel impact preference (e.g., reduce an estimated climate impact associated with a route, etc.), and/or another suitable characteristic and/or preference.

In certain embodiments, the analyzer 252 may be configured determine one or more of the plurality of routes using any of the travel data and/or transportation data described herein. For example, the analyzer 252 may be configured to determined one or more of the plurality of routes using geolocation and/or telematics data associated with the user device 110 (e.g., a current location of the user device 110, etc.), navigation and/or map information associated with a third-party system 130 (e.g., map information from a navigation entity, etc.), information associated with the transportation modality 120 (e.g., a current location of the vehicle, a maintenance or operational status of the vehicle, etc.), policy parameter information associated with the provider system 140 (e.g., historic policy characteristics associated with available routes, etc.), and/or any other suitable data described herein.

In some implementations, the analyzer 252 may also be configured to identify (e.g., determine, calculate, establish, etc.) one or more groups or sets of devices, systems, individuals, entities, and/or a combination thereof. For example, and as described herein, the analyzer 252 may be configured to identify a plurality of routes (e.g., between a first location and a second location, etc.). Using the information associated with the plurality of routes, the analyzer 252 may further be configured to identify a one or more groups of devices or individuals (e.g., traveler devices 114, transportation modalities 120, users or operators associated therewith, etc.), for example which may interact or engage with (e.g., engage, encounter, meet, etc.) one or more of the plurality of available routes. For example, using geolocation and/or telematics data associated with the one or more traveler devices 114 (e.g., obtained via the travel data, etc.), the analyzer 252 may identify a first set of travelers (e.g., associated with a first set of traveler devices 114, etc.) that may interact with a first route, a second set of travelers (e.g., associated with a second set of traveler devices 114, etc.) that may interact with a second route, and/or a third set of travelers (e.g., associated with a second set of traveler devices 114, etc.) that may interact with a third route.

In certain embodiments, the analyzer 252 may be configured to identify one or more groups or sets of devices, systems, individuals, entities, and/or a combination thereof using one or more characteristics (e.g., associated with the devices, systems, individuals, entities, etc.). For example, the analyzer 252 may identify one or more groups or sets using geolocation and/or telematics data (e.g., associated with the devices, etc.). For example, after identify the plurality of routes, the analyzer 252 may obtain (e.g., request, pull, receive, retrieve, etc.) geolocation and/or telematics data of devices, systems, individuals, entities, and/or a combination thereof within a predetermined location (e.g., geofenced area, 1 mile, 2 miles, etc.) around each of the plurality of routes. The analyzer 252 may be configured to obtain geolocation and/or telematics data automatically, via one or more instructions or requests, and/or via another suitable communications protocol.

In some implementations, the analyzer 252 may be configured to identify one or more groups or sets using an association with an entity. For example, the analyzer 252 may be configured to identify a group of devices, systems, individuals, entities, and/or a combination thereof within a predetermined location (e.g., geofenced area, etc.) around each of the plurality of routes using an enrollment or participation in a program offered by an entity (e.g., a program offered by the provider system 140, etc.). In certain implementations, the analyzer 252 may be configured to identify one or more groups or sets using another suitable characteristic, for example a preference. For example, the analyzer may be configured to identify a group of devices, systems, individuals, entities, and/or a combination thereof associated with a preferred demographic (e.g., males between the ages of 18 and 21, males or females between the ages of 70 and 80, etc.) within a predetermined location (e.g., geofenced area, etc.) around each of the plurality of routes. In some implementations, the analyzer 252 may be configured to identify one or more groups or sets using any combination of characteristics and/or other suitable characteristics or qualities described herein (e.g., a geolocation and an enrollment in a program, a geolocation and a preference of a user, etc.).

In certain embodiments, the devices, systems, individuals, entities, and/or combinations thereof may be part of one or more identified group or groups. In some implementations, the analyzer 252 may be configured to obtain information to identify the groups or sets automatically, via one or more instructions or requests, and/or via another suitable communications protocol. It should be understood that while the analyzer 252 is described herein as identifying one or more groups or sets of devices, systems, individuals, entities, and/or a combination thereof within a predetermined location (e.g., geofenced area, etc.) around each of the plurality of routes using certain characteristics, it is contemplated that in some embodiments the one or more groups or sets may be identified using additional or different characteristics (e.g., expected or anticipated travel plans, historic or routine travel locations, routine and/or non-routine travel patterns, etc.), such that the groups or sets identify devices, systems, individuals, entities, and/or combinations thereof that may interact or engage with (e.g., engage, encounter, meet, etc.) one or more of the plurality of available routes.

As shown, the analyzer 252 may be configured to obtain input data (e.g., the request data, etc.), analyze the input data, and/or generate output data. For example, the analyzer 252 may be configured to obtain (e.g., receive, request, pull, etc.) request data (e.g., via the request compiler 250), analyze the request data, and generate route data. As described herein, the route data may identify a plurality of transportation options, for example a plurality of routes. In this regard, the route data may identify a plurality of routes between a first geographic location and a second geographic location.

In some implementations, the analyzer 252 may also be configured to identify one or more groups of devices, systems, individuals, entities, and/or combinations thereof, for example associated with one or more of the plurality of routes. The analyzer 252 may be configured to identify the one or more groups using information obtained (e.g., received, requested, pulled, etc.) automatically, in response to one or more instructions or requests (e.g., generated and/or provided by the analyzer 252 and/or a component of the transportation system 102, etc.), and/or via another communications method, as described herein. In some implementations, the route data may include the one or more identified groups (e.g., associated with each of the plurality of routes, etc.).

In certain embodiments, the score generator 254 may be configured to obtain input data, analyze the input data, and/or generate output data to be communicated to other components of the transportation system 102. For example, the score generator 254 may obtain (e.g., receive, request, pull, etc.) route data, analyze the route data, and/or generate score data, for example including a plurality of scores (e.g., associated with transportation options and/or traveling along routes) associated with the transportation request.

As shown, the score generator 254 may be configured to receive route data. The route data may identify a plurality of transportation options or routes between a first geographic location and a second geographic location. In some embodiments, the route data includes travel data associated with a user (e.g., historic travel data, current travel data, etc.) and/or one or more travel conditions (e.g., road conditions, road elements, traffic densities, traveler speeds, etc.). In certain implementations, the route data includes data identifying one or more groups associated with each of the identified routes. As described herein, the one or more groups may include a set of devices, systems, individuals, entities, and/or combinations thereof that may interact or engage with (e.g., encounter, meet, etc.) one or more of the plurality of available routes.

In certain embodiments, the score generator 254 may be configured to generate a score for each of the plurality of routes. The score may be a risk score or a safety impact score, for example indicating an estimated risk of traveling along the associated route. As described herein, “risk score,” “safety score,” “non-risk score,” “safety impact score,” “safety index,” or other similar terms may represent an estimated (e.g., overall, etc.) risk or potential risk (e.g., potential of an accident and/or associated damage, potential health risk, potential safety risks, potential financial risk, etc.) of traveling along the associated route. In some embodiments, the risk score may consider factors such as, but not limited to, travel tendencies or characteristics of a user (e.g., a tendency to travel cautiously while changing lanes, a tendency to avoid roundabout intersections, a tendency to obey posted speed limits, etc.) and/or other travel-related conditions. As described herein, the travel conditions may be or include route characteristics (e.g., frequently includes traffic, includes construction, involves several stops/starts, includes high/low speeds of travel, etc.), travel tendencies of other travelers along the routes (e.g., tendency to speed, make frequent stops/starts, accelerate/decelerate quickly, etc.), characteristics of other travelers along the routes (e.g., age, gender, travel history, etc.), vehicle characteristics (e.g., anti-lock braking, traction control, electronic stability control, acceleration slip regulation, autonomous cruise control, lane-keep assist systems, etc.), environmental or climate characteristics (e.g., potential or projected adverse weather conditions, frequent freezing or slippery conditions, etc.), and/or other suitable factors or characteristics, as described herein.

As an illustrative example, the score generator 254 may be configured to generate risk scores for four different routes that are available for traveling between an individual's home and work (e.g., using a vehicle owned or operated by the individual, etc.), which may be based upon travel data associated with the user and/or travel conditions (e.g., road geometries, road conditions, etc.). For example, the score generator 254 may generate (1) a first risk (or safety) score for a first available route that travels on the freeway but involves merging across three lanes of traffic to exit, considering historical travel data associated with the user indicating that the user tends to drive cautiously when merging lanes. The score generator 254 may generate (2) a second risk (or safety) score for a second available route that travels on the freeway but exits one exit earlier than the first route and leads to a four-way stoplight, considering historical travel data associated with the user indicating that the user commonly encounters four-way intersections. The score generator 254 may generate (3) a third risk score (or safety) score for a third available route that travels on a side road that encounters several roundabouts, considering historical travel data indicating the user tends to drive cautiously when encountering roundabouts. The score generator 254 may generate (4) a fourth risk score (or safety) score for a fourth available route that travels along a highway that is under construction and experiencing higher-than normal traffic conditions but traveling at posted speeds, considering current travel data indicating the user is currently driving in accordance with common driving patterns and/or historical travel data indicating that the user commonly travels at posted speed limits.

As described herein, one or more risk scores (e.g., safety impact scores, safety indexes, risk impacts, etc.) may be calculated and/or generated using one or more rules, algorithms, and/or models. For example, the score generator 254 may be configured to generate a risk score using one or more rules and/or rule-based logic. For example, the rules may be used to estimate risk, potential risk, and/or another suitable safety metric (e.g., a damage metric, a safety metric, etc.) of traveling along different routes during different transportation scenarios (e.g., at various speeds, during acceleration/deceleration events, during turns, in various locations, etc.), for example by considering information associated with the individual traveler and/or other travel conditions the individual may encounter along the different routes. The rules and/or rule-logic may be used along with historical transportation related data, as discussed elsewhere herein.

In various embodiments, the score generator 254 may be configured to use the historical transportation data to train a predictive model, for example to establish correlations between a safety metric (e.g., potential risk, potential damage, potential injury, etc.) and one or travel locations (e.g., routes, etc.). In some implementations, the predictive model may be trained to establish correlations between a safety metric and an individual and one or more travel conditions. In certain implementations, the score generator 254 may include one or more models and/or artificial intelligence models. For example, the score generator 254 may include one or more regression trees, deep neural networks, supervised learning model, unsupervised learning models, nearest neighbor, generative adversarial (GANs), stable diffusers, generative artificial intelligence (GAI), transformers, or many other types of models.

In certain embodiments, the machine learning models and/or artificial intelligence models may be trained to detect correlations between a safety metric (e.g., risk score, safety impact, etc.) and a travel route, a user and/or operator (e.g., of the transportation modality, etc.), one or more travel conditions (e.g., road conditions, travel conditions, including for example traffic densities, travelers speeds, groups or sets of travelers that a user and/or operator may encounter, etc.), and/or other transportation related parameters.

Additionally or alternatively, the score generator 254 may be configured to generate a score for each of the plurality of routes using a preference. For example, the score generator 254 may generate one or more scores using a preferred route (e.g., or a portion thereof, etc.), a preferred route element (e.g., a preference to avoid roundabouts or large overpasses, etc.), a preferred route characteristic (e.g., a preference to avoid higher-than normal traffic conditions, a preference to avoid construction zones, etc.), a preferred traveler characteristic (e.g., a preference to avoid encountering travelers traveling above posted speeds, travelers that frequently change lanes, travelers of a select demographic, etc.), and/or other suitable preferences described herein. In some embodiments, the score generator 254 may generate one or more scores using a weight factor or rating (e.g., one or more weighting factors between an estimated climate impact, travel time, and/or travel safety, etc.).

In certain embodiments, the score generator 254 may be configured to generate a score that indicates a safety rating or safety index (e.g., a level of exposure to a potential safety hazard, a level of exposure to potential safety risks, etc.) associated with the plurality of routes. In certain implementations, the score generator 254 may be configured to generate a score that indicates an estimated travel time associated with the plurality of routes. Additionally or alternatively, the score generator 254 may be configured to generate one or more scores using a policy parameter (e.g., a coverage, policies, discounts, cost savings, etc.), for example associated with traveling along one or more of the plurality of routes.

As shown, in some embodiments the score generator 254 may also be configured to receive traveler data. In certain implementations, the travel data may be or include the traveler data. In this regard, in some implementations the travel data associated with travel conditions, as described herein, may also include traveler data, for example including information associated with one or more entities the individual may encounter while traveling along one or more of the plurality of available routes. For example, the traveler data may include information associated with one or more devices (e.g., traveler devices 114, etc.), components and/or systems (e.g., transportation modalities 120, third-party system 130, etc.), individuals, entities (e.g., associated with the third-party system 130, etc.), and/or combinations thereof, which are included in the one or more groups that may interact with or engage with (e.g., encounter, meet, etc.) one or more of the plurality of available routes.

In some implementations, the traveler data may be or include data and/or information that is the same and/or similar to travel data. For example, the traveler data may include information associated with one or more traveler devices (e.g., the traveler devices 114). For example, the traveler data may include geolocation and/or telematics data associated with the traveler devices 114 (e.g., a location, a speed, a direction of movement, historic and/or real-time geolocation and/or telematics data, etc.).

Additionally or alternatively, the traveler data may include information associated with a user or operator of one or more devices (e.g., the traveler devices 114 or other computing device(s), including those mentioned herein). For example, the traveler data may include information from one or more applications (e.g., a ride-share application, a transportation rental application, and/or another similar travel application, etc.), information associated with trends and/or tendencies of the user or operator (e.g., a tendency to comply with posted speed limits, travel at reasonable following distances, follow proper rules of the road, level of engagement with the traveler devices 114, etc.), and/or other suitable information.

In some implementations, the traveler data may include information associated with a product or service associated with a user or operator of a device (e.g., the traveler devices 114 or other computing device(s), including those discussed herein.). For example, the traveler data may include information relating to a vehicle associated with a user or operator (e.g., maintenance characteristics or history, safety ratings, etc.), and/or transportation characteristics of the vehicle (e.g., an average travel time or distance, an average number of stops or turns, an average speed of travel, etc.).

In certain implementations, the traveler data may include information collected and/or gathered via a device (e.g., the traveler devices 114). For example, the traveler data may include audiovisual information (e.g., captured via a microphone or camera of the traveler devices 114, and/or captured via a mobile device, AR glasses, VR headset, voice bot, chatbot, wearable, or other computing devices, including those mentioned herein), for example audiovisual (including audio, visual, video, image, and/or graphical information, data, and sensor data) information and related data captured in real-time (e.g., during a travel event) and/or historical audiovisual information and related data.

In certain embodiments, the traveler data may include information associated with a transportation modality (e.g., the transportation modality 120 or transportation mode). In some embodiments, the transportation modality 120 is one of a plurality of transportation modalities 120, such that the traveler data may include information associated with a plurality of transportation modalities 120. In some implementations, the transportation modalities 120 is/are associated with one or more users or operators, which may also be associated with one or more traveler devices 114. As described elsewhere herein, the traveler data may include geolocation and/or telematics data (e.g., historic, real-time, etc.) associated with the transportation modality 120, transportation characteristics of the transportation modality 120 (e.g., travel times, locations, trip lengths, average number of turns, average number of stops/starts, etc.), audiovisual information from the transportation modality 120 (e.g., images, videos, audio, verbal, and/or other data or sensor data, etc.), and/or other suitable information described elsewhere herein

In some implementations, the traveler data may include information associated with a third-party system (e.g., the third-party system 130). In certain implementations, the third-party system 130 is one of a plurality of third-party systems 130, such that the traveler data may include information associated with a plurality of third-party systems 130. For example, the third-party system 130 may be associated with a public entity (e.g., a city or municipality, and/or a public transportation entity), public transportation entities and/or modalities (e.g., bus or trains, etc.), private transportation entities and/or modalities (e.g., planes or shuttles, etc.), transportation network companies and/or modalities (e.g., ride-share services, transportation rental services, users or operators associated with the transportation network companies, etc.), and/or other suitable third-party systems described herein.

In some implementations, the traveler data may include information associated with a provider system 140. As described herein, the provider system 140 may be associated with a company that provides protective services (e.g., insurance, etc.) to a user or operator, a company, service provider, and/or one or more products or services. In some embodiments, the traveler data may include one or more policy parameters associated with one or more users, operators, companies, service providers, products, and/or services.

In certain embodiments, the traveler data may include information associated with a computing system (e.g., the computing system 150) and/or a storage system (e.g., the storage system 160). The traveler data may include historic and/or real-time travel or navigation related information, for example from (e.g., directly, or indirectly) the computing system 150 and/or the storage system 160, as described herein. In some implementations, traveler data may be received by the transportation system 102 in real-time and/or at one or more series or intervals (e.g., continuously, hourly, daily, etc., automatically in response to a travel event initiated and/or associated with the traveler devices 114, the transportation modalities 120, the third-party system 130, the provider system 140, etc.).

In some embodiments, the score generator 254 may be configured to generate a score for each of the plurality of routes. For example, and as described herein, the risk score may consider factors such as, but not limited to, user or operator travel tendencies and/or characteristics (e.g., tendency to speed, tendency to make frequent stops/starts, etc.), route characteristics (e.g., frequently includes traffic, includes construction, involves several stops/starts, includes high/low speeds of travel, etc.), travel tendencies of other travelers along the routes (e.g., tendency to speed, make frequent stops/starts, accelerate/decelerate quickly, etc.), characteristics of other travelers along the routes (e.g., age, gender, travel history, etc.), vehicle characteristics, environmental or climate characteristics, and/or other suitable factors or characteristics described herein.

As an illustrative example, the score generator 254 may be configured to generate risk scores for three different routes that are available for traveling between an individual's home and work (e.g., using a vehicle owned or operated by the individual, etc.). For example, the score generator 254 may generate (1) a first risk (or safety) score for a first available route that only uses sideroads where common travelers tend to travel at posted speed limits, but one that travels past a building where travelers are going to/leaving (e.g., estimated based upon an estimated safety impact associated with the user traveling at posted speeds, but interacting with inexperienced drivers along congested sideroads); (2) a second risk (or safety) score for a second available route that involves traveling on a highway, but one that involves traveling along a section of highway that is under construction (e.g., estimated based upon an estimated safety impact associated with the user traveling under a higher-than normal density conditions and interacting with drivers traveling through road construction conditions); and/or (3) a third risk (or safety) score for a third available route that involves using an express lane on the freeway, but one that involves traveling along the freeway during rush hour (e.g., estimated based upon an estimated safety impact associated with the user that tends to obey posted speed limits interacting with drivers traveling at higher-than normal speeds in higher-than normal traffic conditions).

As described herein, the score generator 254 may be configured to generate a score for each of the plurality of routes using a preference (e.g., a preferred route characteristic, a preferred traveler characteristic, etc.). The score generator 254 may also be configured to generate a score that indicates a safety rating or safety index (e.g., a level of exposure to a potential safety hazard, a level of exposure to potential safety risks, etc.) associated with the plurality of routes, and/or other suitable information (e.g., an estimated travel time, one or more policy parameters, etc.).

As shown, the score generator 254 may be configured to obtain input data (e.g., the route data, traveler data, etc.), analyze the input data, and/or generate output data. For example, the score generator 254 may be configured to obtain (e.g., receive, request, pull, etc.) route data (e.g., via the analyzer 252) and/or traveler data, analyze the route data and/or traveler data, and generate score data. As described herein, the score data may include a score for each of the plurality of routes. In this regard, the score generator 254 may be configured to generate score data that indicates an estimated safety impact (or risk score) of traveling along a plurality of routes.

In certain embodiments, the score generator 254 is configured to communicate data to one or more components of the travel services system 100. For example, the score generator 254 may communicate score data to one or more external systems and/or devices (e.g., the user device 110, the transportation modality 120, etc.). In some implementations, the score data includes a user interface (or voice bot or chat bot, such as a ChatGPT bot) that provides one or more indicators associated with one or more risk (or safety) scores, or otherwise presents one or more risk (or safety) scores and/or associated data, such as visually and/or audibly. As discussed above, in certain implementations the indicators may indicate a level or estimated risk and/or safety impact (e.g., relative to the estimated risks and/or safety impacts of the plurality of routes), such as for choosing to travel along a route.

In some embodiments, the score generator 254 may generate a score data that includes an interface that provides a plurality of risk (or safety) scores (e.g., associated with the plurality of available routes). For example, the score generator 254 may generate a user interface that provides a plurality of risk (or safety) scores (and/or a plurality of associated routes), for example for review (and/or selection) by a user or operator, or otherwise audibly or visually presents the risk (or safety) scores via a user computing device, such as a device display screen or a voice bot.

In various embodiments, the score generator 254 may generate score data that includes one or more indicators. For example, the score generator 254 may generate score data that includes a user interface that includes an indicator indicating a safety index or safety impact rating (e.g., low, medium, high, etc. associated with each risk (or safety) score and/or traveling along each route, etc.), an indicator indicating a travel time (e.g., slowest, medium, fastest, etc. associated with each route, etc.), and/or another suitable indicator (e.g., a risk or safety impact hotspot indicator, a climate impact indicator, a route factor indicator, etc.).

In some embodiments, the score analyzer 256 may be configured to obtain input data, analyze the input data, and/or generate output data to be communicated to other components of the transportation system 102. For example, the score analyzer 256 may obtain (e.g., receive, request, pull, etc.) score data, analyze the score data, and/or generate recommendation data, for example identifying one or more recommended transportation options (e.g., routes) associated with the transportation request.

Additionally or alternatively, the score analyzer 256 may be configured to analyze (e.g., compile, categorize, sort, etc.) the score data. For example, the score analyzer 256 may analyze score data associated with each of the plurality of routes. The score analyzer 256 may analyze the score data to identify a risk (or safety) score (e.g., associated with a route) indicating a lowest estimated risk and/or safety impact (e.g., relative to the estimated risk scores of the plurality of routes) for a route. In some implementations, the score analyzer 256 may analyze (e.g., compiles, categorizes, etc.) the score data to identify a hierarchy of risk (or safety) scores (e.g., indicating a lowest to highest estimated risk and/or safety impact of the plurality of routes).

In various embodiments, the score analyzer 256 may be configured to analyze (e.g., compile, categorize, sort, etc.) the score data using a preference (e.g., a preferred route, a preferred safety impact factor or characteristic, etc.), as described herein. For example, the score analyzer 256 may identify a hierarchy of risk (or safety) scores associated with a preferred route characteristic. The score analyzer 256 may analyze the score data to identify a score that indicates a lowest estimated safety impact rating (e.g., a lowest level of exposure to a potential safety hazard) and/or travel time.

Additionally or alternatively, the score analyzer 256 may analyze the score data using a policy parameter. In some implementations, the score analyzer 256 may identify a hierarchy of risk (or safety) scores (e.g., associated with each route) using the policy parameter. For example, the score analyzer 256 may identify a hierarchy of risk (or safety) scores that provide a user or operator a discount, benefit or reward (e.g., a hierarchy of highest to lowest policy cost (such as a UBI (usage-based insurance) policy cost), most available to least available policy coverage, highest amount of coverage to lowest amount of coverage associated with a route, etc.).

As shown, the score analyzer 256 may be configured to obtain input data (e.g., the score data, etc.), analyze the input data, and/or generate output data. For example, the score analyzer 256 may be configured to obtain (e.g., receive, request, pull, etc.) score data (e.g., via the score generator 254), analyze the score data, and/or generate recommendation data. As described herein, the recommendation data may identify a lowest score and/or a hierarchy of scores (e.g., a lowest risk (or safety) score, a lowest safety impact score, etc.).

In some embodiments, the recommendation generator 258 may be configured to obtain input data, analyze the input data, and/or generate output data to be communicated to other components of the transportation system 102. For example, the recommendation generator 258 may be configured to obtain (e.g., receive, request, pull, etc.) recommendation data, analyze the recommendation data, and generate a transportation recommendation.

The recommendation generator 258 may be configured to obtain (e.g., receive, request, pull) recommendation data (e.g., via the score analyzer 256, etc.). The recommendation generator 258 may analyze (e.g., sort, compile, categorize, etc.) the recommendation data and generate a transportation recommendation. For example, the recommendation generator 258 may generate a transportation recommendation that includes a user interface (or voice bot or chat bot, such as a ChatGPT bot) that provides a recommended route, or otherwise presents a recommendation route and/or associated data, such as visually and/or audibly. As discussed above, in certain implementations the recommended route may indicate a lowest estimated risk and/or safety impact (e.g., relative to the estimated risks and/or safety impacts of the plurality of routes), such as for a route.

In some embodiments, the recommendation generator 258 may generate a transportation recommendation that includes a plurality of recommended routes. For example, the recommendation generator 258 may generate a transportation recommendation that includes a user interface that provides a plurality of routes, for example for review (and/or selection) by a user or operator, or otherwise audibly or visually presents the transportation recommendation via a user computing device, such as a device display screen or a voice bot.

In various embodiments, the recommendation generator 258 may generate a transportation recommendation that includes one or more indicators. For example, the recommendation generator 258 may generate a transportation recommendation that includes an indicator indicating a safety index or safety impact rating (e.g., low, medium, high, etc. associated with each route, etc.), an indicator indicating a travel time (e.g., slowest, medium, fastest, etc. associated with each route, etc.), and/or another suitable indicator (e.g., a risk or safety impact hotspot indicator, a climate impact indicator, a route factor indicator, etc.).

Additionally or alternatively, the recommendation generator 258 may generate a transportation recommendation that includes information relating to one or more policy parameters. For example, the recommendation generator 258 may generate a transportation recommendation that includes a policy parameter (e.g., a cost, coverage, coverage availability, coverage provider, UBI parameters or units, etc.) associated with opting to travel along each route. In some implementations, the at least one policy parameter provides a benefit or reward to a user (e.g., a discount, cost-savings, a cost reduction to an existing policy, an increase in coverage, an increase in duration of coverage of a policy, etc.), for example for choosing to travel with certain travel characteristics (e.g., along a select route, along a safer route, etc.).

In this regard, in certain implementations as a benefit or reward for choosing to travel with certain travel characteristics (e.g., along a select, a recommended, a route having a lower risk score, etc.), a user may be provided with a benefit or reward. In some embodiments, the recommendation generator 258 may generate a transportation recommendation that includes another suitable indicator associated with one or more policy parameters (e.g., a cost-savings associated with each route, an available discount or other cost-saving associated with opting to travel along each route, an electronic communication (e.g., paperless) discount or benefit, etc.).

In certain embodiments, the recommendation generator 258 may be further configured to communicate the transportation recommendation to one or more devices, systems, and/or environments. For example, the recommendation generator 258 may be configured to communicate the transportation recommendation to the user device 110 (e.g., via the communications interface 202), for example for display (e.g., via the user interface 112) or voice reproduction, such as in the case of a voice bot, ChatGPT bot, etc.

Additionally or alternatively, the recommendation generator 258 may be configured to communicate the transportation recommendation to the database 260 and/or the storage system 160 (e.g., via the communications interface 202 via the network 170), for example for storage and/or subsequent transportation recommendation generation. In certain embodiments, the recommendation generator 258 may be configured to communicate the transportation recommendation to the third-party system 130, the provider system 140, and/or the computing system 150 (e.g., via the communications interface 202 via the network 170), for example for storage and/or subsequent analysis (e.g., authorization, verification, etc.).

In various embodiments, the systems, methods, and/or functionalities described herein may be performed in a sequence (e.g., over a period of time, etc.), for example as part of an iterative process, repeated, and/or be otherwise performed. For example, and as described herein, the recommendation generator 258 may generate a transportation recommendation, which may include a recommended route, a plurality of available routes, and/or additional information (e.g., a safety impact score or risk score associated with each route, a policy parameter associated with each route, etc.). The transportation recommendation may be provided to a user or operator (e.g., via a user interface, or otherwise audibly or visually, etc.), and the user may assess the transportation recommendation.

In some implementations, in response to assessing the score data and/or the transportation recommendation, the user or operator may implement one or more actions. For example, a user or operator may select a recommended route as a route to use to travel to their desired destination, and/or the user or operator may select one of the available routes as the route to use to travel to their desired destination. In some embodiments, the user may select the route by interacting with a user device (e.g., via an input provided to the user device 110 via the user interface 112, etc.), and/or by initiating one or more actions (e.g., initiating or starting travel to the desired destination along the selected route, etc.). In certain embodiments, the transportation system 102 may be configured to receive information and/or data associated with the one or more implemented actions (e.g., travel data associated with a travel event, etc.). For example, the transportation system 102 may be configured to receive additional travel data or transportation data (e.g., associated with a travel event, etc.), for example from one or more devices (e.g., the user device 110, the transportation modality 120, etc.).

As described herein, the transportation system 102 may be configured to obtain input data, analyze the data, and/or generate output data to be communicated to other components of the travel services system 100. For example, the transportation system 102 may obtain (e.g., receive, request, pull, etc.) travel or transportation data associated with a travel event associated with a user or operator (e.g., associated with the user device 110, etc.). In certain implementations, the transportation system 102 may be configured to compare the travel or transportation data with one or more sets of score data and/or recommendation data (e.g., a risk (or safety) score, a transportation recommendation or route recommendation, etc.), for example via communication with the database 260. In some implementations, the transportation system 102 may be configured to compare the travel and/or transportation data with the score data and/or the recommendation data, for example to verify that an action associated with the travel and/or transportation data (e.g., a current route of travel of a user, etc.) matches a transportation recommendation (e.g., a recommended route for reducing potential damage and/or risk to a user).

In some implementations, the transportation system 102 may be configured to obtain (e.g., receive, request, pull, etc.) travel and/or transportation data at predetermined intervals. For example, the transportation system 102 may be configured to obtain travel and/or transportation data in real-time or near real-time (e.g., via the user device 110 providing geographic and/or telematics data, the transportation modality 120 providing geographic and/or telematics data, etc.). In some implementations, the transportation system 102 may be configured to obtain travel and/or transportation data at predetermined time intervals (e.g., every hour, 2 hours, 6 hours, 12 hours, 24 hours, bi-weekly, weekly, etc.). In certain implementations, the transportation system 102 may be configured to obtain travel and/or transportation data in response to one or more events and/or actions (e.g., an initiation of a travel event by a user or operator associated with the user device 110, the transportation modality 120, etc.).

In some implementations, the transportation system 102 is configured to monitor one or more components of the travel services system 100. For example, the transportation system 102 may be configured to monitor the user device 110, the traveler devices 114, the transportation modalities 120, the third-party system 130, and/or another suitable device and/or system. In some embodiments, the transportation system 102 is configured to monitor the user device 110 and/or the transportation modality 120 (e.g., geolocation and/or telematics data associated with the user device 110 and/or the transportation modality 120, etc.), for example to determine whether a travel event matches a transportation recommendation (e.g., recommended route, etc.) and/or a selected transportation option (e.g., a selected route).

In certain implementations, the transportation system 102 is configured to monitor the third-party system 130 (e.g., map, navigation, and/or travel information associated with the third-party system 130), for example to determine whether travel conditions (e.g., current conditions, travel patterns, etc.) impact (e.g., change, alter, modify, etc.) the transportation recommendation. For example, the transportation system 102 may be configured to monitor real-time traffic conditions (e.g., traffic densities, traveler speeds, accidents, etc.) based upon information from the third-party system 130, which may be used to make modifications and/or changes to transportation recommendations (e.g., a recommended route, an available route, etc.) for example based upon travel characteristics associated with the user (e.g., a current travel event traveling more cautious than normal, historic travel data indicating a tendency to travel at posted speeds, etc.).

In some embodiments, the transportation system 102 is configured to monitor the traveler devices 114 (e.g., geolocation and/or telematics data associated with the traveler devices 114, etc.), for example to determine whether travel events (e.g., travel patterns, current locations, etc.) associated with the traveler devices 114 impact (e.g., change, alter, modify, etc.) the transportation recommendation. For example, the transportation system 102 may be configured to monitor real-time geolocation and/or telematics information associated with the traveler devices 114, for example to make modifications and/or changes to transportation recommendations (e.g., a recommended route, an available route, etc.) based upon movements and/or locations of the traveler devices 114.

In certain implementations, the transportation system 102 may be configured to generate additional data and/or information (e.g., additional score data, additional recommendation data, additional transportation recommendations, etc.). For example, and as described herein, in response to a user implementing an action (e.g., selecting a route, initiating a travel event along a select route, etc.) the transportation system 102 may generate a transportation recommendation (e.g., a supplemental or additional recommendation, etc.) that includes a user interface that provides an updated policy parameter. Additionally or alternatively, as a benefit or reward for choosing to travel along a recommended route (e.g., a route that includes the lowest risk or lowest safety impact score, etc.), the user may be provided with at least one policy parameter that provides a benefit to the user (e.g., a discount, a cost-savings, a cost reduction to an existing policy, an increase in coverage, an increase in duration of coverage of a policy, etc.).

As also described herein, in some implementations in response to another traveler implementing an action (e.g., changing a course of travel, initiating a travel event while a user is in route, etc.), the transportation system 102 may generate a transportation recommendation (e.g., a supplemental or additional recommendation, etc.) that includes a user interface that provides an updated transportation recommendation (e.g., an updated recommended route, an updated set of available routes, etc.). The transportation system 102 may also provide a user interface that includes one or more policy parameters associated with the updated transportation recommendation. For example, and as described elsewhere herein, as a benefit or reward for choosing to travel along an updated route recommendation, the user may be provided with at least one policy parameter that provides a benefit to the user.

In this regard, the systems, methods, and/or functionalities described herein may be implemented as art of an iterative process, for example to provide users and/or operators with information associated with available actions (e.g., available travel routes, etc.), which may afford users additional benefits and/or advantages. For example, the systems and methods described herein may use different types of travel data (e.g., travel data associated with a user or operator, map and/or navigation information, travel data associated with other travelers, etc.) to generate a transportation recommendation, which may be utilized by users, for example to implement one or more actions. For example, a user may choose to travel along a route that reduces potential damage to products associated with the user and/or other travelers while traveling (e.g., damage to the user's vehicle associated with a potential accident, damage to other traveler's vehicles associated with a potential accident, etc.).

Similarly, a user may choose to ravel along a route that reduces potential health and/or safety risks associated with the user and/or other travelers while traveling (e.g., health and/or safety risks associated with an accident while traveling, etc.). In some implementations, as a benefit or reward for choosing to travel along a route that reduces potential damage, safety, and/or health risks, a user may be provided with at least one policy parameter that provides an additional benefit to the user.

### Exemplary Transportation System & Functionality

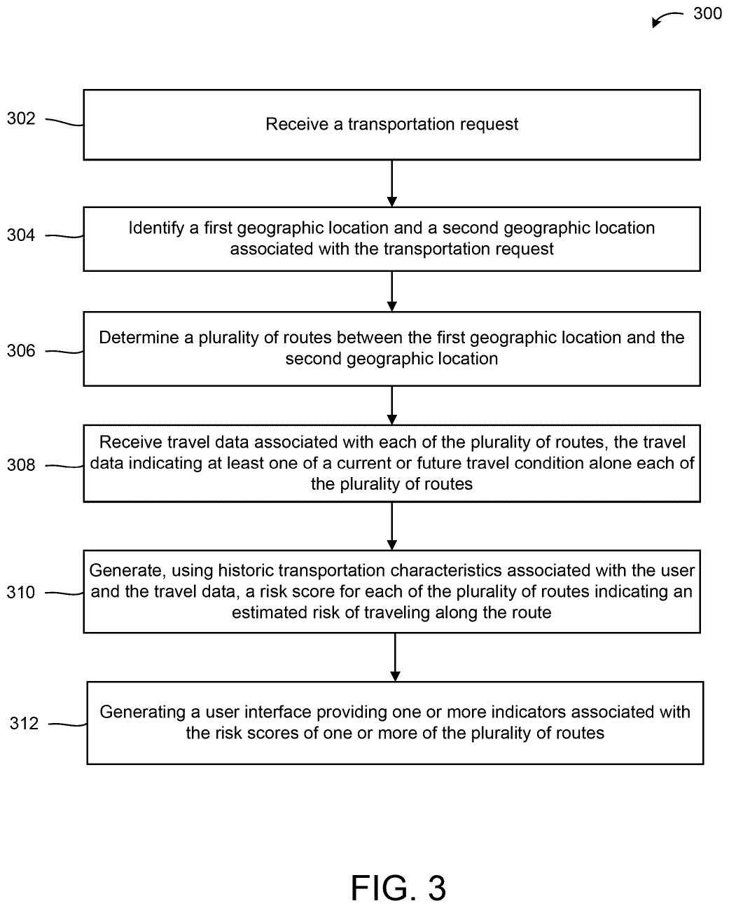

Referring now to FIG. 3, a computer-implemented or computer-based process, shown as process 300, for providing and/or generating a transportation recommendation is shown, according to some embodiments. Computer-implemented process 300 may be implemented by any and/or all the components of the travel services system 100 of FIGS. 1-2 (e.g., the transportation system 102, etc.). It should be appreciated that any and/or all the process 300 may be implemented by other systems, devices, and/or components (e.g., components of the travel services system 100, the transportation system 102, etc.). Further, it should be appreciated that in certain embodiments, process 300 may implemented using additional, different, and/or fewer operations, actions, and/or functionality.

Computer-implemented process 300 may include receiving a transportation request (block 302), according to some implementations. The transportation request may include a geographic location. For example, the transportation request may identify a geographic location a user or operator desires to travel (e.g., work, a grocery store, etc.). The transportation request may be received from an external or remote device (e.g., an edge device, the user device 110, the provider system 140, etc.).

As described herein, the transportation request may include a plurality of geographic locations (e.g., a location a user or operator desires to travel from, a location to avoid, a location to stop, etc.), and/or a preference (e.g., a preference to reduce potential health and/or safety risks, a preference to increase travel efficiency and/or reduce travel time, etc.). In some implementations, the transportation request includes additional travel and/or transportation related information, additional information associated with the request (e.g., a time associated with an initiation and/or communication of the request, etc.), and/or other suitable information.

Computer-implemented process 300 may include identifying a first geographic location and a second geographic location associated with the transportation request (block 304), according to some implementations. As described herein, the transportation request may include a plurality of geographic locations, and a first geographic location and a second geographic location may be identified using the transportation request.

In some implementations, geolocation and/or telematics data associated with the transportation request may be received. For example, geolocation and/or telematics data associated with an external or remote device that initiated the transportation request may be received (e.g., via an edge device, the user device 110, etc.).

The first geographic location and/or the second geographic location may be identified using the geolocation and/or telematics data (and/or the transportation request). For example, a first geographic location (e.g., a user's home) may be identified using the geolocation and/or telematics data (e.g., associated with a device associated with the user, for example the user device 110, the transportation modality 120, etc.), and the second geographic location may be identified using the transportation request (e.g., a request for the user to go to work). Telematics data may be vehicle telematics data, and may include acceleration, braking, cornering, speed, location, heading, GPS, and other data associated with a driver, driver profile, vehicle, vehicle profile, etc.

Computer-implemented process 300 may include determining a plurality of routes between the first geographic location and the second geographic location (block 306), according to some embodiments. For example, a first route may be determined between a user's home and work that involves traveling on a freeway, a second route may be determined that involves traveling on side streets and backroads, and a third route may be determined that involves traveling on a highway, and a third route may be determined that involves traveling on a freeway (e.g., in an express lane into the city).

In various embodiments, one or more of the plurality of routes are determined using travel and/or transportation information, as described here. For example, one or more of the plurality of routes may be determined using mapping and/or navigation related information (e.g., maps, land plots, global positioning information, etc.) associated with a third-party system (e.g., a navigation system and/or application, etc.). Additionally or alternatively, one or more of the plurality of routes may be determined using mapping and/or navigation related information (e.g., maps, land plots, global positioning information, etc.) associated with a city or municipality and/or a public transportation entity. In some implementations, one or more of the plurality of routes may be determined using a preference (e.g., a travel preference associated with the user, etc.), travel and/or transportation data associated with a user, and/or other suitable information described herein.

In some implementations, one or more of the plurality of routes may be determined using transportation schedules and/or other travel related information (e.g., timetables, routes, schedules, historic travel statistics, including delays, number of stops, number of turns, etc.) associated with a public and/or a private transportation entity. In some implementations, one or more of the plurality of routes may be determined using travel information (e.g., historic trips/rentals, travel trends or tendencies, etc.) associated with a transportation network company. Additionally or alternatively, one or more of the plurality of routes may be determined using policy parameter information (e.g., an estimated coverage cost, an estimated coverage availability, etc. associated with a route), associated with a provider system or institution.

Computer-implemented process 300 may also include receiving travel data (block 308), according to some embodiments. For example, the computer-implemented process 300 may include receiving (e.g., identifying, determining, recalling, requesting, etc.) travel data associated with each of the plurality of routes. As described herein, the travel data may include transportation-related layouts and/or geometries (e.g., lane layouts, interchange layouts, on/off ramp layouts, road/rail intersection layouts, lane or shoulder geometries, road or median geometries, etc.), information associated with transportation elements (e.g., bridges, overpasses, interchanges, high-occupancy lanes, roundabouts, cross-walks, bike lanes, etc.), information surrounding potential encounters associated with transportation elements (e.g., deer or cattle crossing, farm machinery crossing, truck crossing, hill warning, truck rollover warning, rail crossing, roadwork or workers ahead, lodging warning, hospital or emergency medical services area, picnic or hiking area, all-terrain vehicle area, snowmobile trail, playground or school zone, etc.), and/or other suitable travel or transportation related information associated with one or more of the plurality of routes, as described herein (e.g., traffic densities, travel speeds, frequency of lane changes, frequency of acceleration/deceleration events, accident information, construction information, weather related information, etc. associated with one or more roads or travel segments, etc.).

In some embodiments, and as described elsewhere herein, the travel data is associated with a current or future travel condition associated with each of the plurality of routes. For example, the travel data may indicate a current traffic density or traveler speed. Further, the travel data may indicate a future (e.g., estimated, projected, etc.) future travel condition associated with each of the plurality of routes. For example, the travel data may indicate (e.g., based upon a time associated with the request, a geolocation of the user, etc.) future travel conditions that include slower-than normal traveling conditions associated with an anticipated lane closure along the first route, slower-than normal traveling conditions due to projected inclement weather along the second route, and/or higher-than normal traffic densities and more frequent lane changes along the third route due to common rush hour traffic.

In some embodiments, the computer-implemented process 300 may also include identifying information and/or data associated with the user. For example, in some implementations the computer-implemented process 300 may include identifying (e.g., receiving, determining, recalling, requesting, etc.) travel and/or transportation related information associated with the user (e.g., historic transportation tendencies, historic transportation characteristics, current travel characteristics, etc.).

As described herein, the travel data may include information associated with travel trends and/or tendencies of the user (e.g., a tendency to travel at a proper speed and/or otherwise obey the posted speed limit, a tendency to accelerate/decelerate as required, a tendency to travel at a reasonable following distance from other vehicles, a tendency to follow proper rules of the road and street signs, a tendency to obey stop signs, etc.), and/or other tendencies or trends of the user while traveling (e.g., a tendency to drive cautiously when merging or changing lanes, a tendency to drive cautiously and/or avoid certain road elements, including, for example, roundabouts, large bridges, overpasses, etc., a tendency to drive cautiously under certain travel conditions, including, for example, high density traffic, wet, icy, snowy, windy, foggy, etc. conditions, etc.).

In certain implementations, the travel data associated with the user includes historic information (e.g., historic and/or frequent trips, historic travel events, historic claims and/or request information, etc.), information associated with a product or service associated with the user (e.g., vehicle information, etc.), information and/or data associated with and/or captured by a device associated with the user (e.g., audiovisual information captured by the user device 110, etc.), and/or other suitable information associated with a user described herein.

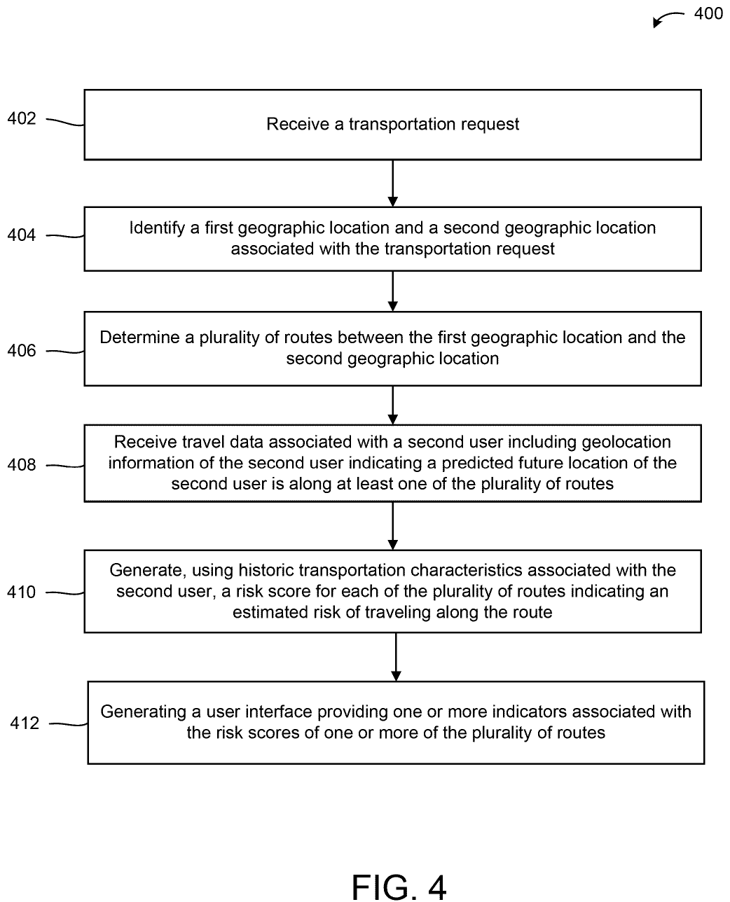

In some implementations, and as will be described herein with reference to FIG. 4, the travel data (e.g., current or future travel conditions, etc.) may be or include information associated with a second user. In this regard, the travel data may include location information (e.g., geolocation information, telematics data, etc.) of a second user, for example indicating that a predicted (e.g., estimated, anticipated, projected, etc.) future location of the second user is along at least one of the plurality of routes. In some implementations, and as described herein, the computer-implemented process 300 may also include identifying historic transportation characteristics associated with the second user.

Computer-implemented process 300 may also include generating a risk (or safety) score for each of the plurality of routes (block 310), according to some embodiments. As described herein, the risk score may indicate an estimate risk of traveling along the associated route (e.g., a risk of potential damage, a risk of potential injury, potential health and/or safety risks, etc.). In some embodiments, the risk score is generated (e.g., determined, identified, etc.) using the transportation characteristics associated with the user (e.g., historic transportation characteristics, current travel characteristics, etc.) and/or the travel data (e.g., indicating a current or future travel condition along a route, etc.). In this regard, the risk score may indicate an estimated risk of the user traveling along an associated route, for example by considering the user's travel characteristics and the potential risks posed by the travel conditions the user may encounter while traveling along that route.

In some implementations, the risk score may be generated using one or more factors and/or sets of information and/or data. For example, in some embodiments the computer-implemented process 300 includes generating risk scores for each of the plurality of routes using (i) transportation characteristics associated with the user (e.g., historic travel tendencies of the user, current travel characteristics of the user, etc.) and (ii) geographic and/or transportation information, or travel conditions, associated with each route (e.g., a road density score, a construction rating, an accident rating, etc. along each of the routes). In this regard, the risk scores may indicate an estimated risk of traveling along a route, for example considering the user's travel tendencies and the potential risks posed by the traveling conditions along each route.

In certain embodiments, the computer-implemented process 300 includes generating risk scores for each of the plurality of routes using (i) historic transportation characteristics associated with a second user and (ii) transportation characteristics and/or data associated with the user (e.g., travel tendencies of the user themselves). In this regard, the risk scores may indicate an estimated risk of traveling along a route, for example considering the traveling characteristics of the user themselves and the potential risks posed by another traveler while traveling along each route.

In certain embodiments, the risk (or safety) score or scores may be generated using any other suitable combination of data and/or information described herein. For example, the risk score or scores may be generated using a preference (e.g., a preferred route, a preferred weighting factor, a preferred travel time, etc.), one or more weighing factors and/or rating (e.g., one or more weighting factors between risk/safety factors and travel time, etc.), and/or other suitable information. In some implementations, the risk score or scores may be generated using one or more policy parameters, for example a discount, UBI unit or parameter, policy cost, policy coverage, a policy availability, and/or other suitable parameter related information associated with one or more of the plurality of routes. In some embodiments, the risk scores for each of the plurality of routes may indicate an estimated travel time associated with the plurality of routes, a safety rating (e.g., a level of exposure to a potential safety hazard) associated with the plurality of routes, and/or another suitable transportation related metric or characteristic.

Computer-implemented process 300 may include generating a user interface (block 312), according to some embodiments. In certain implementations, generating the user interface includes providing one or more indicators associated with the risk scores of one or more of the plurality of routes (e.g., via the user interface). In some implementations, the user interface may be communicated to an external system and/or device (e.g., the user device 110, etc.), for example for display.

As described herein, in addition to and/or in replace of the risk scores, the user interface may include one or more indicators. The indicators may also include a safety impact or safety index rating associated with each route. In some implementations, the one or more indicators include travel time indicators, route indicators, safety factor or risk factor indicators, and/or other visual and/or audible indicators (e.g., a heatmap indicator associated with a route, etc.). In some implementations, the user interface further includes one or more indicators associated with a policy parameter (e.g., for example a cost, a coverage type, a coverage duration, a coverage availability, etc. associated with opting to travel along one or more of the available routes).

In certain implementations, an external system and/or device (e.g., the user device 110, etc.) may present and/or display the user interface, for example providing indicators associated with the risk scores of one or more of the plurality of available routes for display and/or review (e.g., to a user). The computer-implemented process 300 may include receiving a selection of a selected route, for example selected from one of the plurality of available routes. As described herein, the selection may be in the form of receiving an input (e.g., via an interaction with the user interface, the display, etc.), and/or one or more implemented actions (e.g., a determination of a user starting travel along a selected route, for example via analysis of geolocation and/or telematics data associated with the user, etc.). In certain implementations, computer-implemented process 300 may also include generating and/or providing at least one policy parameter associated with the user opting to travel along the selected route.

As described herein, in some implementations, as a benefit or reward for selecting and/or traveling along a route (e.g., a route that exhibits the lowest risk score, poses the lowest potential risk, damage, injury, and/or health or safety risks, etc.), one or more policy parameters may be provided that offer a benefit or reward to the user (e.g., a discount, a cost savings, an expansion of coverage, an expansion of term, etc.). In some embodiments, the one or more policy parameters are provided based upon historical data associated with a user (e.g., a history of opting to travel along safer routes, a history of traveling with safe travel characteristics or tendencies, etc.). In this regard, the one or more policy parameters may be provided based upon a series of implemented actions (e.g., travel choices, travel options, etc.) associated with a ser.

In some implementations, the computer-implemented process 300 includes selecting a recommend route from the plurality of routes, according to some embodiments. In some embodiments, the computer-implemented process 300 includes selecting a recommended route from the plurality of routes, for example based upon a risk score indicating a lowest estimated risk score (e.g., relative to the risk scores of opting to travel along each of the plurality of routes).

In some embodiments, a recommended route may be selected using one or more policy parameters. For example, in some implementations a recommended route may be selected based upon a potential benefit and/or reward afforded to a user or operator, for example by traveling along the recommended route. As described herein, the one or more policy parameters may offer a lower cost associated with a policy premium of an associated route (e.g., costs associated with one or more UBI (usage-based insurance) coverages or policies, etc.), a higher overall coverage of a policy associated with a route, a higher overall coverage of persons or vehicles traveling along an associated route, and/or another suitable policy parameter characteristic (e.g., available discounts, coverages, policy terms/limits, UBI parameters, etc.).

In some implementations, the recommended route may be one of a plurality of available routes (e.g., two, three, four, five, 10, etc. available routes). In this regard, in some implementations the computer-implemented process 300 may include generating and/or providing a plurality of available routes and/or associated information (e.g., risk scores, risk indicators, information associated with the risk scores, etc.), for example for assessment by a user and/or operator. As described herein, a user or operator may assess (e.g., evaluate, analyze, etc.) the available routes and/or associated information (e.g., risk scores, risk factors, safety indexes, etc.), for example to select a route to travel to a desired destination.

In certain embodiments, the computer-implemented process 300 may include generating a user interface, according to some embodiments. In certain implementations, generating the user interface includes providing the recommended route (e.g., via the user interface). In some implementations, the user interface may be communicated to an external system and/or device (e.g., the user device 110, etc.), for example for display. As described herein, in addition to and/or in replace of the recommended route, the user interface may include one or more indicators (e.g., risk scores, a safety impact or safety index rating, travel time indicators, route indicators, safety factor or risk factor indicators, etc.), and/or other visual and/or audible indicators (e.g., a heatmap indicator associated with a route, etc.).

As described herein, in some implementations the computer-implemented process 300 may include generating the user interface including the plurality of available routes. An external system and/or device (e.g., the user device 110, etc.) may present and/or display the user interface, for example providing the plurality of available routes for display and/or review (e.g., to a user). The computer-implemented process 300 may include receiving a selection of a selected route, for example selected from one of the plurality of available routes. As described herein, the selection may be in the form of receiving an input (e.g., via an interaction with the user interface, the display, etc.), and/or one or more implemented actions (e.g., a determination of a user starting travel along a selected route, for example via analysis of geolocation and/or telematics data associated with the user, etc.).

In certain implementations, computer-implemented process 300 may also include generating and/or providing at least one policy parameter associated with the selected route. As described herein, in some implementations, as a discount, benefit or reward for selecting and/or traveling along a recommended route (e.g., a route that exhibits the lowest risk score, poses the lowest potential risk, damage, injury, and/or health or safety risks, etc.), one or more policy parameters may be provided that offer a benefit or reward to the user (e.g., a discount, a cost savings, an expansion of coverage, an expansion of term, etc.).

As an illustrative example, a user or operator may desire to travel from a first location (e.g., their home) to a second location (e.g., their work). In some implementations, the user or operator may desire to travel with the aim of reducing the potential risks, for example considering the travel characteristics (e.g., historic, current, etc.) of the user themselves and/or the risks posed by the travel conditions (e.g., current or future travel conditions, including, for example, route geometries, road elements encountered, traffic densities, traveler speeds, etc.) along each of the routes (e.g., potential damage, injury, health/safety risks, etc.) and/or other factors while traveling.

In some embodiments, a user (e.g., via an application housed and/or executed on a user device) may initiate a transportation request, for example indicating that the user desires to travel to a select location (e.g., work). Based upon the transportation request and/or geolocation and/or telematics data (e.g., communicated along with the transportation request), a first location (e.g., a user's home) and a second location (e.g., the user's work) may be identified. Using the first location and the second location, a plurality of routes between the first location and the second location may be identified.

The plurality of routes may be determined using mapping and/or navigation related information, as well as travel information associated with other third-party sources (e.g., reported accidents or construction events, etc.). For example, (i) a first route may be identified that involves traveling along a freeway, (ii) a second route may be identified that involves traveling along a freeway but exits one exit earlier than the first route, (iii) a third route may be identified that involves traveling along side roads or back roads, and/or (iv) a fourth route may be identified that involves traveling along a highway.

In some embodiments, travel data associated with each of the routes may be received. For example, for each of the plurality of routes, travel data associated with the route may be received, where the travel data indicates a current or future travel condition (e.g., associated with each of the routes, etc.). The travel data may include road geometries (e.g., on/off ramp configurations, number of lanes, intersection controls, etc.) and/or road conditions, as described herein. For example, it may be determined that (i) the first route involves traveling on the freeway, but involves merging across three lanes of traffic to exit, (ii) the second route involves traveling on the freeway and exiting one exit earlier than the first lane, and leads to a four-way stoplight at the end of the off ramp, (iii) the third route involves traveling on a side road the encounters several roundabouts, and/or (iv) the fourth route involves traveling on a highway that is under construction.

Further, the travel data may include road and/or traveler conditions (e.g., common or current traffic densities, frequency of lane changes, traveler speeds, accidents, construction events, etc.), and/or any other suitable traffic data described herein. For example, it may be determined that (e.g., current or future conditions, etc.) (i) the first route involves travelers traveling at slightly-higher than normal speeds, (ii) the second route involves less traffic density than normal conditions, (iii) the third route involves normal traffic densities and travelers traveling at posted speeds, and/or (iv) the fourth route involves higher-than normal traffic densities and travelers traveling at posted speeds.

In certain embodiments, additional information and/or data may be identified and/or determined. For example, transportation characteristics (e.g., historic travel tendencies or habits, current travel characteristics, etc.) of the user themselves may be identified. As described herein, the travel characteristics may include travel tendencies or characteristics (e.g., a tendency to obey posted speed limits, a tendency to drive cautiously in high-density conditions or when encountering certain intersection controls, for example roundabouts, etc.). For example, it may be determined that the user (i) tends to drive more cautiously than normal when merging lanes, (ii) commonly encounters controlled intersections, (iii) uncommonly encounters roundabouts and tends to drive more cautiously than normal when encountering roundabouts, and/or (iv) tends to drive more cautiously than normal in higher-density traffic conditions and/or drives at posted speed limits.

In some embodiments, a risk score for each of the plurality of routes may be generated, where the risk scores indicate the estimated risk (e.g., potential damage, injury, health and/or safety concerns, etc.) associated with traveling along the route. In certain implementations, the risk scores are generated using the transportation characteristics associated with the user (e.g., travel habits, travel tendencies, current travel characteristics, etc.) and the travel data (e.g., travel conditions, etc.) associated with each of the routes. In this regard, the risk scores may indicate an estimated risk associated with traveling along each route, for example considering the user's travel characteristics and the risks posed by the travel conditions along each route.

For example, (i) a first risk (or safety) score may be generated associated with the first route, which involves traveling on the freeway with travelers traveling at slightly-higher than normal speeds, and which requires merging across three lanes of traffic to exit, considering the user's tendency to drive cautiously when merging lanes. Further, (ii) a second risk (or safety) score may be generated associated with the second route, which involves traveling on the freeway with less-than normal traffic density, which exits one exit earlier than the first route and leads to a four-way stoplight, considering the user commonly encounters four-way intersections. Further, (iii) a third risk (or safety) score may be generated associated with the third route, which involves traveling on a side road with normal traffic densities and travelers traveling at posted speeds, but which encounters several roundabouts, considering the user's inexperience with roundabouts and/or tendency to drive cautiously when encountering roundabouts. Yet further, (iv) a fourth risk (or safety) score may be generated associated with the fourth route, which involves traveling along a highway under construction with higher-than normal traffic density and travelers traveling at posted speeds, considering the user is currently driving in accordance with common driving patterns and/or that the user commonly travels at posted speed limits.

The risk scores may be provided to a user (e.g., via the user interface). In some embodiments, a user interface is provided to a user that includes one or more indicators (e.g., numerical values, color indicators, etc.) associated with the risk scores of one or more of the plurality of routes. The indicators may allow a user to assess the relative estimated risk and/or potential risks associated with traveling along each route, for example to allow the user to opt to travel along a route that reduces potential risks to the user and/or others.

In some implementations, using the risk scores associated with each of the available routes, a recommended route may be selected and/or provided to a user (e.g., via the user interface). For example, a recommended route may be selected that reduces and/or limits an estimated risk and/or potential risks associated with traveling. And using the illustrative example outlined above, a second available route that involves traveling on the freeway and exiting one exit earlier than the first route, but which involves less-than normal traffic density and includes a controlled intersection, which the user commonly encounters, may be recommended to the user based upon the driving characteristics of the user and/or the travel conditions associated with the route, for example compared to a first route that involves merging across three lanes of travelers traveling at higher-than normal speeds when the user is generally cautious in merging lanes, and/or a third route that involves several roundabouts when the user is inexperienced with roundabouts and/or tends to drive more cautiously. In some implementations, all of the available routes and/or associated information (e.g., risk scores, risk factors, etc.) may be provided to the user, for example to allow the user to assess available options and/or implement travel decisions that reduce potential risks and/or provide additional benefits to the user, as discussed herein.

### Additional Exemplary Transportation System & Functionality

Referring now to FIG. 4, a computer-implemented or computer-based process, shown as process 400, for providing and/or generating a transportation recommendation is shown, according to some embodiments. Computer-implemented process 400 may be implemented by any and/or all the components of the travel services system 100 of FIGS. 1-2 (e.g., the transportation system 102, etc.). It should be appreciated that any and/or all the process 400 may be implemented by other systems, devices, and/or components (e.g., components of the travel services system 100, the transportation system 102, etc.). Further, it should be appreciated that in certain embodiments, process 400 may implemented using additional, different, and/or fewer operations, actions, and/or functionality.

Computer-implemented process 400 may include receiving a transportation request (block 402), according to some implementations. The block 402 may be or include similar features or components as block 302 of FIG. 3. For example, the transportation request may identify a geographic location a user or operator desires to travel (e.g., work, a grocery store, etc.), and/or may be received from an external or remote device (e.g., an edge device, the user device 110, the provider system 140, etc.).

Computer-implemented process 400 may include identifying a first geographic location and a second geographic location associated with the transportation request (block 404), according to some implementations. The block 404 may be or include similar features or components as block 304 of FIG. 3. For example, the transportation request may include a plurality of geographic locations, and a first geographic location and a second geographic location may be identified using the transportation request.

Computer-implemented process 400 may include determining a plurality of routes between the first geographic location and the second geographic location (block 406), according to some embodiments. The block 406 may be or include similar features or components as block 306 of FIG. 3. For example, one or more of the plurality of routes may be determined using travel and/or transportation information, as described here (e.g., mapping and/or navigation related information, for example associated with a third-party system, a navigation system and/or application, etc.).

Computer-implemented process 400 may also include receiving information associated with another user or operator (block 408), according to some embodiments. In some embodiments, the travel data described herein is or includes information associated with another user. For example, the travel data described at block 308 of FIG. 3 may include travel data associated with another user. In this regard, in some embodiments one or more of the features and/or steps of the process 400 of FIG. 4 may be implemented in combination with the features and/or steps of the process 300 of FIG. 3.

In some embodiments, the computer-implemented process 400 may include receiving travel information associated with a second user. The travel information may include location information (e.g., geolocation information, telematics data, etc.) of the second user, for example indicating that a predicted (e.g., estimated, anticipated, projected, etc.) future location of the second user is along at least one of the plurality of routes. For example, in response to determining one or more available routes, geolocation and/or telematics data associated with a second user (and/or a plurality of second users) may be received.

Using the geolocation and/or telematics data associated with the second user, a predicted (e.g., estimated, projected, etc.) future location of the second user may be determined. If the predicted future location of the second user is determined to encounter (e.g., intersect, engage, contact, meet, etc.) one or more locations along one or more of the available routes, the second user may be identified as a part of one or more groups or sets (e.g., of potential individuals or travelers the user may encounter along an associated route), as described herein. In this regard, and as described herein, the computer-implemented process 400 may include identifying (e.g., determining, etc.) one or more groups or sets of travelers (e.g., via a predicted future location of the travelers, etc.) that a user may encounter along one or more available travel routes.

As described herein, the second user may be a user associated with a device, system, individual, entity, and/or a combination thereof. In some implementations, the second user is one of a plurality of users and/or operators. As such, the computer-implemented process 400 may include receiving information (e.g., geolocation information, telematics data, etc.) associated with a plurality of other users and/or operators. In some implementations, the geolocation information may be received automatically (e.g., the second user opting-in to share geolocation information, etc.), in response to an input (e.g., from the second user, etc.), and/or in response to another prompt and/or instruction (e.g., a request, call, query, etc.). As also described herein, the second user may also be determined and/or identified (e.g., as part of the group of set of travelers, etc.), for example using one or more other characteristics, qualities, and/or traits associated with the second user (e.g., an enrollment or participation in a program offered by an entity, a demographic of the second user, a preference of the user, etc.).

In some implementations, the computer-implemented process 400 may also include identifying historic transportation characteristics associated with the second user. For example, the computer-implemented process 400 may include identifying (e.g., receiving, determining, recalling, requesting, etc.) historic transportation characteristics associated with the second user. As described herein, historic transportation characteristics may include driving habits and/or travel tendencies (e.g., a tendency to travel at a proper speed and/or otherwise obey the posted speed limit, a tendency to accelerate/decelerate as required, a tendency to travel at a reasonable following distance from other vehicles, a tendency to follow proper rules of the road and street signs, a tendency to obey stop signs, etc.). In some implementations, historic transportation characteristics may include other travel related tendencies (e.g., a level of engagement with a user device, a level of engagement with a microphone or camera within a vehicle, a user of maps or other direction-related applications, etc.). In certain implementations, historic transportation characteristics include historic claims and/or request data (e.g., associated with the second user, etc.), information associated with a vehicle or transportation modality (e.g., associated with the second user, etc.), and/or any other suitable information and/or data described herein.

In certain implementations, and as described elsewhere herein, the computer-implemented process 400 may also include identifying information and/or data associated with one or more routes (e.g., as described at least with reference to FIG. 3). For example, in some embodiments the computer-implemented process 400 may include identifying (e.g., receiving, determining, recalling, requesting, etc.) geographic information and/or data associated with one or more routes. As described herein, the information and/or data may include, for example, a road density score indicating a number of crossroads along a route, a construction rating indicating one or more construction events along a route, an obstruction rating indicating one or more obstruction events along a route, and/or other similar and/or suitable information (e.g., an available express lane, high occupancy lane, etc.).

In some embodiments, the computer-implemented process 400 may also include identifying information and/or data associated with the user (e.g., as described at least with reference to FIG. 3). For example, in some implementations the computer-implemented process 400 may include identifying (e.g., receiving, determining, recalling, requesting, etc.) travel and/or transportation related information associated with the user. As described herein, the travel data may include information associated with travel trends and/or tendencies of the user, and/or other tendencies or trends of the user while traveling. In some implementations, historic information associated with the user may be received, information associated with a product or service associated with the user may be received (e.g., vehicle information, etc.), information and/or data associated with and/or captured by a device associated with the user may be received, and/or other suitable information associated with a user described herein.

Computer-implemented process 400 may also include generating a risk (or safety) score for each of the plurality of routes (block 408), according to some embodiments. As described herein, the risk score may indicate an estimate risk of traveling along the associated route (e.g., a risk of potential damage, a risk of potential injury, potential health and/or safety risks, etc.). In some embodiments, the risk score is generated (e.g., determined, identified, etc.) using the historic transportation characteristics, for example associated with the second user. In this regard, the risk score may indicate an estimated risk of traveling along an associated route, for example by considering the potential risks posed by another traveler (e.g., the second user) the user may encounter while traveling along that route.

In some implementations, the risk score may be generated using one or more factors and/or sets of information and/or data. For example, in some embodiments the computer-implemented process 400 includes generating risk scores for each of the plurality of routes using (i) historic transportation characteristics associated with the second user (e.g., travel tendencies of the second user, etc.) and (ii) geographic and/or transportation information associated with each route (e.g., a road density score, a construction rating, an accident rating, etc. along each of the routes). In this regard, the risk scores may indicate an estimated risk of traveling along a route, for example considering the potential risks posed by another traveler and the traveling conditions along each route. In certain embodiments, the computer-implemented process 400 includes generating risk scores for each of the plurality of routes using (i) historic transportation characteristics associated with the second user and (ii) transportation characteristics and/or data associated with the user (e.g., travel tendencies of the user themselves). In this regard, the risk scores may indicate an estimated risk of traveling along a route, for example considering potential risks posed by another traveler and/or the traveling characteristics of the user themselves while traveling along each route.

In certain embodiments, the risk (or safety) score or scores may be generated using any other suitable combination of data and/or information described herein. For example, the risk score or scores may be generated using a preference, one or more weighing factors and/or rating, and/or other suitable information. In some implementations, the risk score or scores may be generated using one or more policy parameters, an estimated travel time associated with the plurality of routes, a safety rating (e.g., a level of exposure to a potential safety hazard) associated with the plurality of routes, and/or another suitable transportation related metric or characteristic.

Computer-implemented process 400 may include generating a user interface (block 412), according to some embodiments. In certain implementations, and as described with reference to the computer-implemented process 300 of FIG. 3, generating the user interface may include providing one or more indicators associated with the risk scores of one or more of the plurality of routes (e.g., via the user interface), and/or the user interface may be communicated to an external system and/or device (e.g., the user device 110, etc.), for example for display. In addition to and/or in replace of the risk scores, the user interface may include one or more indicators (e.g., a safety impact or safety index rating associated with each route, travel time indicators, route indicators, safety factor or risk factor indicators, and/or other visual and/or audible indicators, including for example a heatmap indicator associated with a route, etc.). In some implementations, the user interface further includes one or more indicators associated with a policy parameter (e.g., for example a cost, a coverage type, a coverage duration, a coverage availability, etc. associated with opting to travel along one or more of the available routes).

In certain implementations, an external system and/or device (e.g., the user device 110, etc.) may present and/or display the user interface, for example providing indicators associated with the risk scores of one or more of the plurality of available routes for display and/or review (e.g., to a user). The computer-implemented process 400 may include receiving a selection of a selected route, for example selected from one of the plurality of available routes, as described herein. As described herein, in some implementations, as a benefit or reward for selecting and/or traveling along a route (e.g., a route that exhibits the lowest risk score, poses the lowest potential risk, damage, injury, and/or health or safety risks, etc.), one or more policy parameters may be provided that offer a benefit or reward to the user (e.g., a discount, a cost savings, an expansion of coverage, an expansion of term, etc.).

In some implementations, the computer-implemented process 400 includes selecting a recommend route from the plurality of routes. In some embodiments, the computer-implemented process 400 includes selecting a recommended route from the plurality of routes (e.g., based upon a risk score indicating a lowest estimated risk score, using one or more policy parameters, as described herein). As described herein, a user or operator may assess (e.g., evaluate, analyze, etc.) the available routes and/or associated information (e.g., risk scores, risk factors, safety indexes, etc.), for example to select a route to travel to a desired destination. In certain implementations, computer-implemented process 400 may also include generating and/or providing at least one policy parameter associated with the selected route (e.g., as a discount, benefit or reward for selecting and/or traveling along a recommended route, etc.).

As an illustrative example, a user or operator may desire to travel from a first location (e.g., their home) to a second location (e.g., their work). In some implementations, the user or operator may desire to travel with the aim of reducing the potential risks, for example risks posed by other travelers (e.g., potential damage, injury, health/safety risks, etc.) and/or other factors while traveling. In some embodiments, a user may initiate a transportation request, for example indicating that the user desires to travel to a select location (e.g., work). Based upon the transportation request and/or geolocation and/or telematics data (e.g., communicated along with the transportation request), a first location (e.g., a user's home) and a second location (e.g., the user's work) may be identified. Using the first location and the second location, a plurality of routes between the first location and the second location may be identified.

The plurality of routes may be determined using mapping and/or navigation related information, as well as travel information associated with other third-party sources (e.g., reported accidents or construction events, etc.). For example, (i) a first route may be identified that involves traveling along side roads, (ii) a second route may be identified that involves traveling along a highway, and (iii) a third route may be identified that involves traveling along a freeway.

In some embodiments, travel data (e.g., geolocation, telematics, etc. data) associated with a second user may be received. For example, using the plurality of routes, travel data associated the second user may be received (e.g., geolocation, telematics, etc. data), for example indicating that a predicted future location of the second user is along one or more of the plurality of routes. Using the routes and/or the travel data associated with one or more other travelers (e.g., geolocation data, predicted or estimated location data, etc.), it may be determined that a user is expected to encounter (i) an inexperienced driver along the first route, (ii) an abnormal traveler along the second route, and/or (iii) a routine traveler along the third route. In certain embodiments, historic transportation characteristics (e.g., travel tendencies, travel habits, etc.) of the second user may be identified, for example a tendency to speed, make frequent stops, and/or to accelerate/decelerate quickly.

Similarly, and as described elsewhere herein, historic transportation characteristics associated with the user themselves may be identified (e.g., a tendency to speed, make frequent stops/starts, accelerate/decelerate quickly, etc.), factors and/or characteristics associated with each route may be identified (e.g., frequently includes traffic, includes construction, involves several stops/starts, etc.), and/or other suitable information and/or data may be identified (e.g., environmental or climate characteristics, vehicle characteristics, etc.). For example, it may be determined that a user is expected to encounter (i) a travelers traveling to/from a school along the first route, (ii) travelers following a detour through construction along the second route, and/or (iii) travelers traveling along a standard path through rush hour traffic along the third route.

In some embodiments, a risk score for each of the plurality of routes may be generated, where the risk scores indicate the estimated risk (e.g., potential damage, injury, health and/or safety concerns, etc.) associated with traveling along the route. In certain implementations, the risk scores are generated using the historic transportation characteristics associated with the second user (e.g., travel habits, travel tendencies, etc.). In this regard, the risk scores may indicate an estimated risk associated with traveling along each route, for example considering the risks posed by the second user. For example, (i) a first risk score may be generated associated with the first route, which considers the driving characteristics of an inexperienced driver that the user may encounter; (ii) a second risk score may be generated associated with the second route, which considers the driving characteristics of a driver that is not familiar with the route/road that the user may encounter; and/or (iii) a third risk score may be generated associated with the third route, which considers the driving characteristics of a driver traveling along their normal route.

In some implementations, the risk scores are generated using a combination of information and/or data. In various embodiments, the risk scores may be generated using (i) historic transportation characteristics associated with the second user and (ii) information and/or characteristics associated with each of the routes. For example, (i) a first risk score may be generated associated with the first route, which considers the driving characteristics of an inexperienced driver traveling along with other inexperienced drivers; (ii) a second risk score may be generated associated with the second route, which considers the driving characteristics of a driver not familiar with the route/road, for example traveling outside of their normal route along a posted detour on the highway; and/or (iii) a third risk score may be generated associated with the third route, which considers the driving characteristics of a driver traveling along their normal route to work using the express lane on the freeway during rush hour.

In some implementations, the risk scores may be generated using (i) historic transportation characteristics associated with the second user and (ii) travel and/or transportation characteristics associated with the user themselves. For example, (i) a first risk score may be generated associated with the first route, which considers the driving characteristics of the inexperienced driver and the user in encountering the inexperienced driver; (ii) a second risk score may be generated associated with the second route, which considers the driving characteristics of the non-familiar driver and the user driving along a construction route; and/or (iii) a third risk score may be generated associated with the third route, which considers the driving characteristics of a driver familiar with the route and the user driving during rush hour traffic.

The risk scores may be provided to a user (e.g., via the user interface). In some embodiments, a user interface is provided to a user that includes one or more indicators (e.g., numerical values, color indicators, etc.) associated with the risk scores of one or more of the plurality of routes. The indicators may allow a user to assess the relative estimated risk and/or potential risks associated with traveling along each route, for example to allow the user to opt to travel along a route that reduces potential risks to the user and/or others.

In some implementations, using the risk scores associated with each of the available routes, a recommended route may be selected and/or provided to a user (e.g., via the user interface). For example, a recommended route may be selected that reduces and/or limits an estimated risk and/or potential risks associated with traveling. And using the illustrative example outlined above, a third available route that involves using an express lane on a freeway during rush hour may be recommended to the user based upon the driving characteristics of the other drivers and/or the user, for example compared to a first route that involves the risk averse user encountering an inexperienced driver, and a second route that involves the construction-naïve user encountering an unfamiliar traveler while traveling along a construction detour. In some implementations, all of the available routes and/or associated information (e.g., risk scores, risk factors, etc.) may be provided to the user, for example to allow the user to assess available options and/or implement travel decisions that reduce potential risks and/or provide additional benefits to the user, as discussed herein.

### Exemplary User Interface Displaying Transportation Options

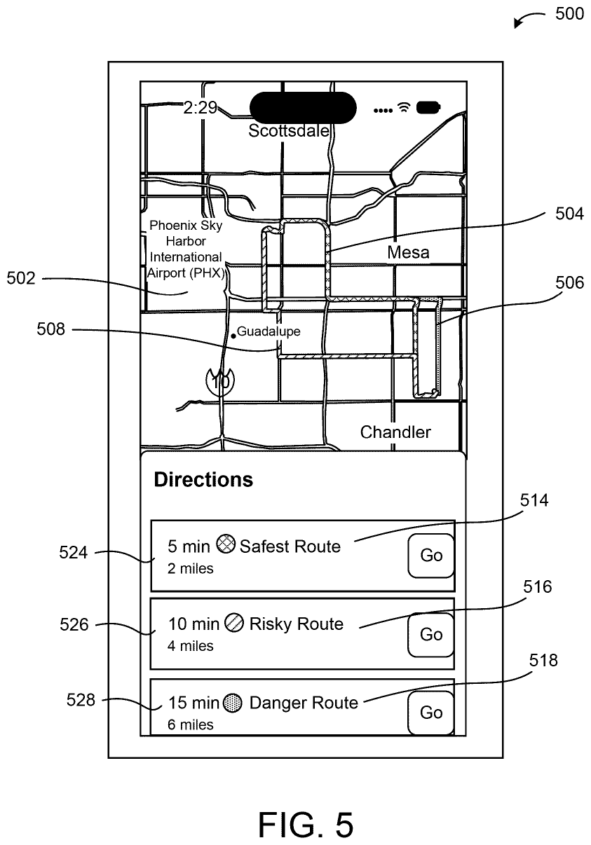

Referring to FIG. 5, a computer-generated user interface, shown as user interface 500, is shown, according to some implementations. The user interface 500 may be generated by any and/or all of the components of the travel services system 100 of FIGS. 1-2 (e.g., the transportation system 102, etc.). It should be appreciated that any and/or all of the user interface 500 may be implemented by other systems, devices, and/or components (e.g., components of the travel services system 100, the transportation system 102, etc.). It should be appreciated that in certain embodiments, user interface 500 may be implemented using additional, different, and/or fewer operations, actions, and/or functionality.

As shown in FIG. 5, the user interface 500 may include a navigation pane or map (item 502), one or more transportation options or transportation routes (item 504, 506, 508), and one or more transportation option indicators. In some implementations, the map (item 502) displays navigation and/or transportation information associated with a geographic area. The transportation routes (item 504, 506, 508) may indicate one or more available routes between one or more geographic locations. For example, the transportation routes (item 504, 506, 508) may indicate a first available route for a user to use to travel to work (item 504), a second available route for a user to use to travel to work (item 506), and/or a third available route for a user to use to travel to work (item 508).

In some implementations, the user interface 500 may include one or more transportation option indicators. For example, the user interface 500 may include one or more safety impact indicators, for example associated with each of the one or more transportation options. The safety impact indicators may indicate a safety index or safety impact rating (e.g., low, medium, high, etc.), for example associated with the risk score, safety impact score, and/or safety index score, as described herein (e.g., a potential safety impact and/or risk associated with the respective route, etc.). As shown, the user interface 500 may include a first safety index indicator (item 514), for example associated with the first transportation route (item 504), a second safety index indicator (item 516), for example associated with the second transportation route (item 506), and/or a third safety index indicator (item 518), for example associated with the third transportation route (item 508).

In some implementations, the user interface 500 may also include one or more travel time indicators, for example associated with each of the one or more transportation options. As shown, the user interface 500 may include a first travel time indicator (item 524), for example associated with the first transportation route (item 504), a second travel time indicator (item 526), for example associated with the second transportation route (item 506), and/or a third travel time indicator (item 528), for example associated with the third transportation route (item 508).

In certain implementations, the user interface 500 may also include one or more selectable indicators. For example, the user interface 500 may include one or more selectable indicators associated with each of the one or more transportation options, which may be used to facilitate a user selecting (e.g., choosing, determining, etc.) one or the available transportation routes to travel to the desired destination. In some implementations, the user interface 500 may be dynamically updated, for example to display an updated interface including step-by-step instructions for traveling along the selected route, notifications associated with the selected route, and/or other suitable transportation and/or travel related information associated with a selected route (e.g., accident notifications, construction notifications, weather notifications, etc.).

### Exemplary User Interface Displaying Transportation Recommendation

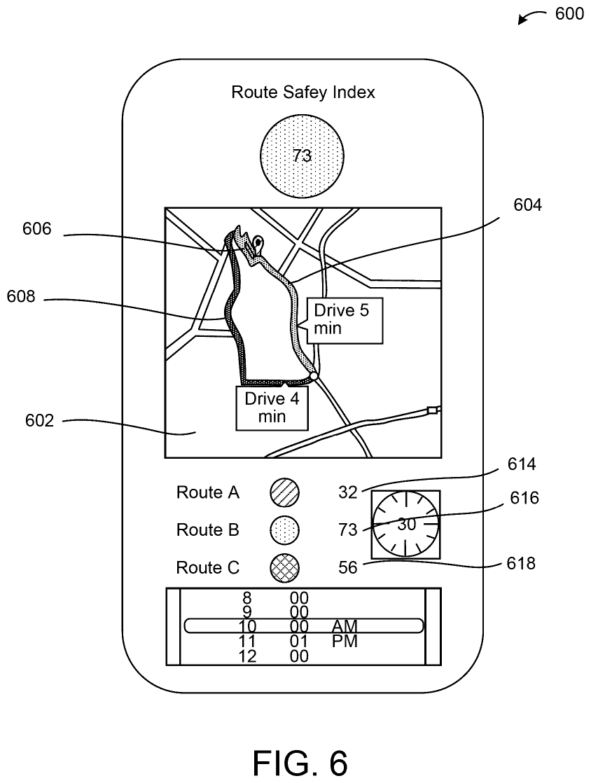

Referring to FIG. 6, a computer-generated user interface, shown as user interface 600, is shown, according to some embodiments. The user interface 600 may be generated by any and/or all of the components of the travel services system 100 of FIGS. 1-2 (e.g., the transportation system 102, etc.). It should be appreciated that any and/or all of the user interface 600 may be implemented by other systems, devices, and/or components (e.g., components of the travel services system 100, the transportation system 102, etc.). It should be appreciated that in certain embodiments, user interface 600 may be implemented using additional, different, and/or fewer operations, actions, and/or functionality.

As shown in FIG. 6, the user interface 600 may include a navigation pane or map (item 502), one or more transportation options or transportation routes (item 604, 606, 608), and one or more transportation option indicators. In some implementations, the map (item 602) displays navigation and/or transportation information associated with a geographic area. The transportation routes (item 604, 606, 608) may indicate one or more available routes between one or more geographic locations. For example, the transportation routes (item 604, 606, 608) may indicate a first available route for a user to use to travel to work (item 604), a second available route for a user to use to travel to work (item 606), and/or a third available route for a user to use to travel to work (item 608).

In some implementations, the user interface 600 may include one or more transportation option indicators. For example, the user interface 600 may include one or more safety impact indicators, for example associated with each of the one or more transportation options. The safety impact indicators may indicate a safety index or safety impact rating (e.g., low, medium, high, etc.), for example associated with the risk score, safety impact score, and/or safety index score, as described herein (e.g., a potential safety impact and/or risk associated with the respective route, etc.). The safety impact indicators may be displayed via one or more numeric or alphanumeric values, a color or shape, and/or another suitable audible and/or visual indicator. As shown, the user interface 600 may include a first safety index indicator (item 614), for example associated with the first transportation route (item 604), a second safety index indicator (item 616), for example associated with the second transportation route (item 606), and/or a third safety index indicator (item 618), for example associated with the third transportation route (item 608).

In some implementations, the user interface 600 may also include one or more transportation option recommendations. For example, the user interface 600 may modify (e.g., highlight, bold, etc.) a recommended route of the one or more transportation options (e.g., available routes), for example indicating that select route as the recommended route. As described herein, the recommended route may be selected based upon the risk score, safety impact score, and/or safety index score, for example a route that reduces or is the lowest safety impact and/or risk score (e.g., reduces or limits potential damage and/or injury associated with traveling along the recommended route compared to the risks associated with traveling along the other available routes). As shown, the safety impact indicator (e.g., the number, score, etc.) associated with the recommended route may be displayed via the user interface 600.

In certain implementations, the user interface 600 may also include one or more selectable indicators. For example, the user interface 600 may include one or more selectable indicators associated with each of the one or more transportation options, which may be used to facilitate a user selecting (e.g., choosing, determining, etc.) one or the available transportation routes to travel to the desired destination. In some implementations, the user interface 600 may be dynamically updated, for example to display an updated interface including instructions for traveling along the selected route, notifications associated with the selected route, and/or other suitable transportation and/or travel related information associated with a selected route (e.g., accident notifications, construction notifications, weather notifications, etc.).

Exemplary User Interface Displaying Index Factors Associated with a Transportation Recommendation

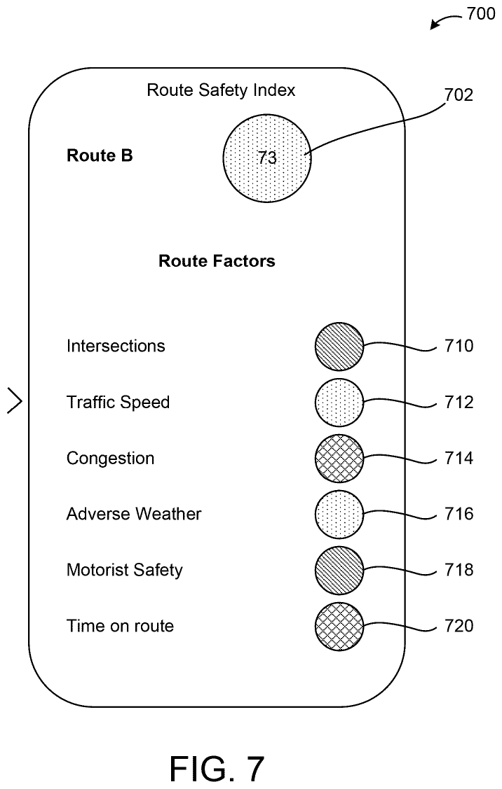

Referring to FIG. 7, a computer-generated user interface, shown as user interface 700, is shown, according to some embodiments. The user interface 700 may be generated by any and/or all of the components of the travel services system 100 of FIGS. 1-2 (e.g., the transportation system 102, etc.). It should be appreciated that any and/or all of the user interface 700 may be implemented by other systems, devices, and/or components (e.g., components of the travel services system 100, the transportation system 102, etc.). It should be appreciated that in certain embodiments, user interface 700 may be implemented using additional, different, and/or fewer operations, actions, and/or functionality.

As shown in FIG. 7, the user interface 700 may include a safety index, safety impact rating, or risk score (item 702). In some implementations, the safety index (item 702) may be associated with a selected route. For example, in response to selecting a route (e.g., via interaction with the user interfaces 500, 600 of FIGS. 5, 6), user interface 700 including the safety index (item 702) may be generated and/or displayed. As described elsewhere herein, the safety index may be associated with the risk score, safety impact score, and/or safety index score associated with the selected route. Further, the safety index may be displayed via one or more numeric or alphanumeric values, a color or shape, and/or another suitable audible and/or visual indicator.

In some implementations, the user interface 700 may include one or more safety or route factor indicators (item 710, 712, 714, 716, 718, 720). For example, the computer-generated interface may include indicators associated with factors used in generating and/or determining the safety index (e.g., safety and/or route-related factors associated with each of the available routes in generating and/or determining the safety index). As shown, the user interface 700 may include a route intersection factor indicator (item 710), a route traffic speed indicator (item 712), a route congestion factor indicator (item 714), a route weather indicator (item 716), a route safety indicator (item 718), and a route time indicator (item 720). The indicators may indicate a safety index or safety impact rating (e.g., low, medium, high, etc.) associated with each of the indicators and/or factors used in generating and/or determining the safety index (e.g., associated with each route).

It should be understood that while the user interface 700 is shown to include certain exemplary indicators and/or factors, it is contemplated that the user interface 700 may include additional and/or different indicators and/or factors described elsewhere herein. For example, the factors and/or indicators may relate to route characteristics (e.g., frequently includes traffic, includes construction, involves several stops/starts, includes high/low speeds of travel, etc.), travel tendencies of other travelers along the routes (e.g., tendency to speed, make frequent stops/starts, accelerate/decelerate quickly, etc.), characteristics of other travelers along the routes (e.g., age, gender, travel history, etc.), user or operator travel tendencies and/or characteristics (e.g., tendency to speed, tendency to make frequent stops/starts, etc.), vehicle characteristics (e.g., anti-lock braking, traction control, electronic stability control, acceleration slip regulation, autonomous cruise control, lane-keep assist systems, etc.), environmental or climate characteristics (e.g., potential or projected adverse weather conditions, frequent freezing or slippery conditions, etc.), and/or other suitable factors or characteristics described herein.

### Exemplary User Interface Displaying Transportation Recommendation

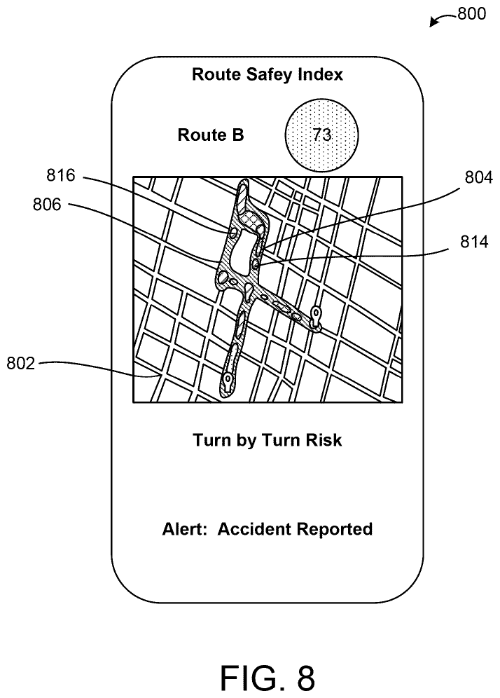

Referring to FIG. 8, a computer-generated user interface, shown as user interface 800, is shown, according to some embodiments. The user interface 800 may be generated by any and/or all of the components of the travel services system 100 of FIGS. 1-2 (e.g., the transportation system 102, etc.). It should be appreciated that any and/or all of the user interface 800 may be implemented by other systems, devices, and/or components (e.g., components of the travel services system 100, the transportation system 102, etc.). It should be appreciated that in certain embodiments, user interface 800 may be implemented using additional, different, and/or fewer operations, actions, and/or functionality.

As shown in FIG. 8, the user interface 800 may include a navigation pane or map (item 802), one or more transportation options or transportation routes (item 804, 806), and one or more transportation option indicators. In some implementations, the map (item 802) displays navigation and/or transportation information associated with a geographic area. The transportation routes (item 804, 806) may indicate one or more available routes between one or more geographic locations. For example, the transportation routes (item 804, 806) may indicate a first available route for a user to use to travel to work (item 804), and/or a second available route for a user to use to travel to work (item 806).

In some implementations, the user interface 800 may include one or more transportation option indicators. For example, the user interface 800 may include one or more safety impact indicators, for example associated with each of the one or more transportation options (e.g., associated routes, etc.). As described elsewhere herein, the safety impact indicators may indicate a safety index or safety impact rating (e.g., low, medium, high, etc.), for example associated with the risk score, safety impact score, and/or safety index score, as described herein (e.g., a potential safety impact and/or risk associated with the respective route, etc.). Further, the safety impact indicators may indicate a safety index or safety impact rating, for example at different locations along the transportation option (e.g., the associated route).

For example, the safety impact indicators may be displayed via one or more heatmaps (e.g., a safety index heatmap, a risk heatmap, etc.). Further, in some implementations the safety impact indicators may also be displayed via one or more numeric or alphanumeric values, a color or shape, and/or another suitable audible and/or visual indicator. As shown, the user interface 800 may include a first safety index indicator or risk heatmap (item 814), for example associated with the first transportation route (item 804), and a second safety index indicator or risk heatmap (item 816), for example associated with the second transportation route (item 806). A shown, the safety index indicator or risk heatmap may illustrate a risk or safety index along each of the associated routes.

In certain implementations, the user interface 800 may also include one or more selectable indicators. In some implementations, the user interface 800 may include step-by-step instructions for traveling along the selected route, notifications associated with the selected route, and/or other suitable transportation and/or travel related information associated with a selected route (e.g., accident notifications, construction notifications, weather notifications, etc.).

### Exemplary Machine Learning and Generative AI

As discussed elsewhere, some embodiments may utilize machine learning, generative artificial intelligence, or other advanced computing techniques. As such, in certain embodiments, generative artificial intelligence (AI) models (also referred to as generative machine learning (ML) models) and/or other AI/ML models discussed herein may be implemented via and/or coupled to one or more voice bots and/or chatbots that may be configured to utilize artificial intelligence and/or machine learning techniques. For instance, the voice and/or chatbot may be a ChatGPT chatbot and/or a ChatGPT-based bot. The voice and/or chatbot may employ supervised, unsupervised, and/or semi-supervised machine learning techniques, which may be followed by, and/or used in conjunction with, reinforced and/or reinforcement learning techniques. The voice bot, chatbot, ChatGPT bot, ChatGPT-based bot, and/or other such generative model may generate audible or verbal output, text or textual output, visual or graphical output, output for use with speakers and/or display screens of a mobile computing device, and/or other types of output for user and/or other computer or bot consumption.

Noted above, in certain implementations, a chatbot or other computing device may be configured to implement machine learning, such that the computing device “learns” to analyze, organize, and/or process data without being explicitly programmed. Machine learning and/or artificial intelligence may be implemented through machine learning methods and algorithms. In one exemplary embodiment, a machine learning module may be configured to implement the ML methods and algorithms.

As used herein, a voice bot, chatbot, ChatGPT bot, ChatGPT-based bot, and/or other such generative model (referred to broadly as “chatbot” herein) may refer to a specialized system for implementing, training, utilizing, and/or otherwise providing an AI or ML model to a user for dialogue interaction (e.g., “chatting”). Depending on the embodiment, the chatbot may utilize and/or be trained according to language models, such as natural language processing (NLP) models and/or large language models (LLMs). Similarly, the chatbot may utilize and/or be trained according to generative adversarial network (GAN) techniques, such as the machine learning techniques, algorithms, and systems described in more detail below.

The chatbot may receive inputs from a user via text input, spoken input, gesture input, etc. The chatbot may then use AI and/or ML techniques as described herein to process and analyze the input before determining an output and displaying the output to the user. Depending on the embodiment, the output may be in a same or different form than the input (e.g., spoken, text, gestures, etc.), may include images, and/or may otherwise communicate the output to the user in an overarching dialogue format.

In various embodiments, at least one of a plurality of ML methods and algorithms may be applied to implement and/or train the chatbot, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, a chatbot ML module employs supervised learning, which involves identifying patterns in existing data to make predictions about subsequently received data. Specifically, the chatbot ML module may be “trained” using training data, which includes example inputs and associated example outputs. Based upon the training data, the chatbot ML module may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiment, a processing element may be trained by providing it with a large sample of data with known characteristics or features.

In another embodiment, the chatbot ML module may employ unsupervised learning, which involves finding meaningful relationships in unorganized data. Unlike supervised learning, unsupervised learning does not involve user-initiated training based upon example inputs with associated outputs. Rather, in unsupervised learning, the chatbot ML module may organize unlabeled data according to a relationship determined by at least one ML method/algorithm employed by the chatbot ML module. Unorganized data may include any combination of data inputs and/or ML outputs as described above.

In yet another embodiment, the chatbot ML module may employ semi-supervised learning, which involves using thousands of individual supervised machine learning iterations to generate a structure across the multiple inputs and outputs. In this way, the chatbot ML module may be able to find meaningful relationships in the data, similar to unsupervised learning, while leveraging known characteristics or features in the data to make predictions via a ML output.

In yet another embodiment, the chatbot ML module may employ reinforcement learning, which involves optimizing outputs based upon feedback from a reward signal. Specifically, the chatbot ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In certain embodiments, the chatbot ML module may be used in conjunction with the machine vision, image recognition, object identification, AR glasses, VR headsets, other input/output devices, and/or other image processing techniques discussed below. Additionally or alternatively, in some embodiments, the chatbot ML module may be configured and/or trained to implement one or more aspects of the machine vision, image recognition, objection identification, and/or other image processing techniques discussed below.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In some embodiments, a computer program is provided, and the program is embodied on a computer readable medium. In certain embodiments, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some implementations, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes.

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method operations, actions, or functionality may be varied or re-sequenced according to alternative embodiments. Other substitutions, modifications, changes, and omissions may be made in the design, operating conditions, and arrangement of the example embodiments without departing from the scope of the present disclosure.

As used herein, an element or operation recited in the singular and proceeded with the word “a” or “an” should be understood as not excluding plural elements or operations, unless such exclusion is explicitly recited. Furthermore, references to “exemplary embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed under 35 U.S.C. § 112(f) unless traditional means-plus-function language is expressly recited, such as “means for” or “step for” language being expressly recited in the claim(s).

Although the Figures show a specific order of method operations, actions, or functionality, the order of such may differ from what is depicted. Also, two or more operations, actions, or functionalities may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection operations or actions, processing operations or actions, comparison operations or actions, and decision operations or actions.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the functionality and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. Additionally or alternatively, the operations may be performed by a combination of one or more central or offsite computing devices/servers and one or more local controllers/computing devices. All such implementations are contemplated within the scope of the present disclosure.

Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A transportation system for generating a transportation recommendation, the system comprising:
one or more memory devices having instructions stored thereon that, when executed by one or more processors, cause the one or more processors to perform operations comprising:
receiving a transportation request associated with a user;
identifying, using the transportation request, a first geographic location and a second geographic location associated with the transportation request;
determining, using the first geographic location and the second geographic location, a plurality of routes between the first geographic location and the second geographic location;
receiving travel data associated with each of the plurality of routes, the travel data indicating at least one of a current or predicted future travel condition along each of the plurality of routes;
generating, using historic transportation characteristics associated with the user and the travel data, a risk score for each of the plurality of routes, the risk score indicating an estimated risk of traveling along the route; and
generating a user interface providing one or more indicators associated with the risk scores of one or more of the plurality of routes.

2. The transportation system of claim 1, wherein the historic transportation characteristics associated with the user includes at least one of an average transportation speed, an average number of stops during a travel event, or an average travel time.

3. The transportation system of claim 1, wherein the current or predicted future travel conditions indicate at least one of a road density score indicating a number of crossroads along a route, a construction rating indicating one or more construction events along a route, or an obstruction rating indicating one or more obstruction events along a route.

4. The transportation system of claim 1, wherein the current or predicted future travel conditions indicate at least one of a traveler speed along a route, a frequency of traveler lane changes along a route, a frequency of traveler acceleration along a route, and a frequency of traveler deceleration along a route.

5. The transportation system of claim 1, wherein the operations comprise:
receiving travel data associated with the user, the travel data indicating a real-time travel characteristic associated with the user, the real-time travel characteristic including a current transportation speed of the user compared to an average transportation speed associated with the user; and
wherein generating the risk scores for each of the plurality of routes includes generating the risk scores for each of the plurality of routes using the travel data associated with the user.

6. The transportation system of claim 1, wherein the operations comprise:
providing a recommended route of the plurality of routes, wherein the recommended route has a risk score indicating a lowest estimated risk of the estimated risks of traveling along each of the plurality of routes.

7. The transportation system of claim 1, wherein the operations further comprise:
receiving user travel data including geolocation information of the user as the first travels between the first geographic location and the second geographic location; and
comparing the user travel data with historical travel data associated with the plurality of routes to verify a recommended route.

8. The transportation system of claim 7, wherein the operations further comprise:
providing, using the verification of the recommended route, the user interface including at least one insurance policy parameter associated with opting to travel along the recommended route.

9. The transportation system of claim 1, wherein the operations further comprise:
receiving a user preference indicating a relative preference between travel characteristics associated with traveling between the first geographic location and the second geographic location; and
selecting a recommended route from the plurality of routes using the user preference.

10. The transportation system of claim 1, wherein generating the user interface includes providing the risk scores for each of the plurality of routes.

11. The transportation system of claim 1, wherein the operations further comprise:
receiving a selection of a route from the plurality of routes; and
providing, using the selected route, a recommended route via the user interface.

12. A computer-implemented method for generating a transportation recommendation, the computer-implemented method comprising:
receiving a transportation request;
identifying, using the transportation request, a first geographic location and a second geographic location associated with the transportation request;
determining, using the first geographic location and the second geographic location, a plurality of routes between the first geographic location and the second geographic location;
determining geographic data associated with each of the plurality of routes;
receiving travel data associated with a second user, the travel data including geolocation information of the second user indicating a predicted future location of the second user is along at least one of the plurality of routes;
generating, using historic transportation characteristics associated with the second user and the geographic data, a risk score for each of the plurality of routes, the risk score indicating an estimated risk of traveling along the route; and
generating a user interface providing one or more indicators associated with the risk scores of one or more of the plurality of routes.

13. The computer-implemented method of claim 12, wherein the travel data including the geolocation information of the second user is received in real-time.

14. The computer-implemented method of claim 12, wherein the historic transportation characteristics of the second user includes at least one of an average transportation speed, an average number of stops during a travel event, or an average travel time.

15. The computer-implemented method of claim 12, wherein a first user and the second user are enrolled in a transportation program associated with an entity.

16. The computer-implemented method of claim 12, further comprising:
providing a recommended route of the plurality of routes, wherein the recommended route has a risk score indicating a lowest estimated risk of the estimated risks of traveling along each of the plurality of routes.

17. A non-transitory computer readable medium comprising instructions stored thereon that, when executed by one or more processors, cause the one or more processors to perform operations comprising:
receiving a transportation request;
identifying, using the transportation request, a first geographic location and a second geographic location associated with the transportation request;
determining, using the first geographic location and the second geographic location, a plurality of routes between the first geographic location and the second geographic location;
receiving transportation data associated with a first user, the transportation data including historic transportation characteristics of the first user;
receiving travel data associated with a second user, the travel data including geolocation information of the second user indicating a predicted future location of the second user is along at least one of the plurality of routes;
generating, using the historic transportation characteristics of the first user and historic transportation characteristics of the second user, a risk score for each of the plurality of routes, the risk score indicating an estimated risk of traveling along the route; and
generating a user interface providing indicators associated with each of the risk scores of each of the plurality of routes.

18. The non-transitory computer readable medium of claim 17, wherein the operations further comprise:
receiving geographic data associated with each of the plurality of routes; and
generating the risk scores for each of the plurality of routes using the geographic data.

19. The non-transitory computer readable medium of claim 18, wherein the geographic data includes at least one of a road density score indicating a number of crossroads along a route, a construction rating indicating one or more construction events along a route, or an obstruction rating indicating one or more obstruction events along a route.

20. The non-transitory computer readable medium of claim 17, wherein the operations further comprise:
providing a recommended route of the plurality of routes, wherein the recommended route has a risk score indicating a lowest estimated risk of the estimated risks of traveling along each of the plurality of routes.
